(19) United States
(12) Patent Application Publication
(10) Pub. No.: US 2024/0394343 A1
(43) Pub. Date: Nov. 28, 2024

(54) METHOD AND SYSTEM OF RUNNING APPLICATION, ELECTRONIC DEVICE AND STORAGE MEDIUM

(71) Applicants: Beijing BOE Technology Development Co., Ltd., Beijing (CN); BOE TECHNOLOGY GROUP CO., LTD., Beijing (CN)

(72) Inventor: Zhenjun Shao, Beijing (CN)

(21) Appl. No.: 18/758,080

(22) Filed: Jun. 28, 2024

Related U.S. Application Data
(63) Continuation-in-part of application No. 18/725,307, filed on Jan. 1, 0001.

(51) Int. Cl. G06F 21/10; G06F 21/44

(52) U.S. Cl. CPC G06F 21/105; G06F 21/44

(57) ABSTRACT

A method and a system of running an application, an electronic device and a storage medium are provided. The method includes: acquiring an authorization code, where the authorization code is used to authorize the terminal device to run the application; acquiring a license information; extracting a device fingerprint and an authorization code associated with the device fingerprint from the license information; generating a verification result by comparing the authorization code extracted from the license information with the acquired authorization code and comparing the device fingerprint extracted from the license information with a device fingerprint of the terminal device; and allowing the terminal device to run the application or prohibiting the terminal device from running the application, according to the verification result.

### CROSS-REFERENCE TO RELATED APPLICATION(S)

This application is a CIP application of U.S. patent application Ser. No. 18/725,307, filed on Jun. 28, 2024, which is a Section 371 National Stage Application of International Application No. PCT/CN2023/095813, filed on May 23, 2023, entitled “METHOD OF RUNNING APPLICATION, ELECTRONIC DEVICE AND STORAGE MEDIUM”, the content of which is incorporated herein by reference in its entirety.

### TECHNICAL FIELD

The present disclosure relates to a field of computer technology, in particular to a method and a system of running an application, an electronic device, and a storage medium.

### BACKGROUND

With the development and maturity of container technology, many software or IT companies begin to use container technology. While containers bring convenience to applications, they also bring some problems. For example, it is easy to copy and steal unauthorized applications within the containers, and the applications may not be protected.

### SUMMARY

The present disclosure provides a method and a system of running an application, an electronic device, and a storage medium.

According to an aspect of the present disclosure, a method of running an application, performed by a terminal device, is provided, the method including: acquiring an authorization code, where the authorization code is configured to authorize the terminal device to run the application; acquiring a license information; extracting a device fingerprint and an authorization code associated with the device fingerprint from the license information; generating a verification result by comparing the authorization code extracted from the license information with the acquired authorization code and comparing the device fingerprint extracted from the license information with a device fingerprint of the terminal device; and allowing the terminal device to run the application or prohibiting the terminal device from running the application, according to the verification result.

For example, the generating a verification result by comparing the authorization code extracted from the license information with the acquired authorization code and comparing the device fingerprint extracted from the license information with a device fingerprint of the terminal device includes: if the authorization code extracted from the license information is matched with the acquired authorization code and the device fingerprint extracted from the license information is matched with the device fingerprint of the terminal device, determining the verification result as a pass; otherwise, determining the verification result as a fail; and the allowing the terminal device to run the application or prohibiting the terminal device from running the application according to the verification result includes: allowing the terminal device to run the application if the verification result is a pass; and prohibiting the terminal device from running the application if the verification result is a fail.

For example, the method further includes: extracting application information from the license information, and comparing the application information extracted from the license information with an information of the application to be run; where the generating a verification result by comparing the authorization code extracted from the license information with the acquired authorization code and comparing the device fingerprint extracted from the license information with a device fingerprint of the terminal device includes: if the application information extracted from the license information is matched with the information of the application to be run, the authorization code extracted from the license information is matched with the acquired authorization code and the device fingerprint extracted from the license information is matched with the device fingerprint of the terminal device, generating the verification result as a pass; otherwise, generating the verification result as a fail.

For example, the acquiring an authorization code includes: registering with an offline authorization server; receiving the authorization code from the offline authorization server in response to a successful registration, where the offline authorization server is in the same local area network as the terminal device.

For example, the acquiring a license information includes: sending a verification request for the application to the offline authorization server; and receiving the license information from the offline authorization server.

For example, the method further includes: after acquiring the license information, storing the license information locally.

For example, the method further includes: extracting an authorization validity period for the application from the license information; verifying whether the authorization validity period is valid; and prohibiting the terminal device from running the application, in response to the authorization validity period being invalid.

For example, the verifying whether the authorization validity period is valid includes: determining the authorization validity period to be valid, in response to the authorization validity period extracted from the license information being consistent with an authorization validity period stored locally on the terminal device; or determining the authorization validity period to be invalid, in response to the authorization validity period extracted from the license information being inconsistent with the authorization validity period stored locally on the terminal device.

For example, the verifying whether the authorization validity period is valid includes: determining the authorization validity period to be valid, in response to a current time being within the authorization validity period extracted from the license information; or determining the authorization validity period to be invalid, in response to the current time being outside the authorization validity period extracted from the license information.

For example, the method further includes: generating an initial string according to a device identifier of the terminal device; and encrypting the initial string to obtain the device fingerprint.

For example, the extracting a device fingerprint and an authorization code associated with the device fingerprint from the license information includes: decrypting the license information; and parsing the decrypted license information to obtain the device fingerprint and the authorization code associated with the device fingerprint.

According to an aspect of the present disclosure, a method of running an application, performed by an offline authorization server, is provided, the method including: acquiring a list of authorization codes from a credit platform; sending one of the authorization codes in the list to a terminal device, in response to the terminal device being registered to the offline authorization server; sending a license information to the terminal device in response to receiving a verification request from the terminal device, so that the terminal device performs the above-mentioned method.

For example, the method further includes: before sending the authorization code to the terminal device, determining whether a number of authorized terminal devices exceeds a predetermined threshold; where the operation of sending the authorization code to the terminal device is performed in response to the number of authorized terminal devices not exceeding the predetermined threshold.

According to an aspect of the present disclosure, a method of running an application, performed by a terminal device, is provided, the method including: acquiring an authorization code, where the authorization code is configured to authorize the terminal device to run the application; sending a device fingerprint of the terminal device and the authorization code; receiving a verification result, where the verification result is generated according to the device fingerprint and the authorization code; and allowing the terminal device to run the application or prohibiting the terminal device from running the application, according to the verification result.

For example, the acquiring an authorization code includes: registering with a credit platform; and receiving the authorization code from the credit platform in response to a successful registration.

According to an aspect of the present disclosure, a method of running an application, performed by a credit platform, is provided, the method including: sending one of a plurality of authorization codes in a pre-stored list of authorization codes to a terminal device, in response to the terminal device being registered with the credit platform; acquiring from the terminal device a device fingerprint of the terminal device and an authorization code, in response to receiving from the terminal device a verification request for the application to be run; generating a verification result according to the device fingerprint of the terminal device and the authorization code received from the terminal device; and sending the verification result to the terminal device.

According to an aspect of the present disclosure, a system of running an application is provided, including a credit platform, an offline authorization server, and a terminal device, where the credit platform is configured to send a list of authorization codes to the offline authorization server; where the offline authorization server is configured to acquire the list of authorization codes from the credit platform, send one of the authorization codes in the list to the terminal device in response to the terminal device being registered with the offline authorization server, and send a license information to the terminal device in response to receiving a verification request from the terminal device; and where the terminal device is configured to perform the above-mentioned method.

According to an aspect of the present disclosure, a system of running an application is provided, including a credit platform and a terminal device, where the credit platform is configured to send one of a plurality of authorization codes in a pre-stored list of authorization codes to the terminal device in response to the terminal device being registered to the credit platform, acquire from the terminal device a device fingerprint of the terminal device and an authorization code, in response to receiving from the terminal device a verification request for the application to be run, generate a verification result according to the device fingerprint of the terminal device and the authorization code received from the terminal device, and send the verification result to the terminal device; and where the terminal device is configured to perform the above-mentioned method.

According to an aspect of the present disclosure, an electronic device is provided, including: at least one processor; and a memory communicatively connected to the at least one processor, where the memory stores instructions executable by the at least one processor, and the instructions are configured to, when executed by the at least one processor, cause the at least one processor to implement the above-mentioned methods.

According to an aspect of the present disclosure, a non-transitory computer-readable storage medium having computer instructions therein, where the computer instructions are configured to cause a computer to implement the above-mentioned methods.

It should be understood that the content described in this section is not intended to identify key or important features of embodiments of the present disclosure, nor is it intended to limit the scope of the present disclosure. Other features of the present disclosure will be easily understood through the following description.

### BRIEF DESCRIPTION OF THE DRAWINGS

The accompanying diagrams are used for better understanding of this scheme, which do not constitute a limitation on the present disclosure, in which:

FIG. 1 is a schematic flowchart of a method of running an application according to an embodiment of the present disclosure;

FIG. 2 is a schematic diagram of a principle of an online mode of a single machine and single container scene according to an embodiment of the present disclosure;

FIG. 3 is a schematic diagram of a principle of an offline mode of a single machine and single container scene according to an embodiment of the present disclosure;

FIG. 4 is a schematic diagram of a principle of a deployment architecture of a host in an offline mode of a single machine and single container scene according to an embodiment of the present disclosure;

FIG. 5 is a schematic diagram of a principle of an online mode of a single machine and a plurality of containers scene according to an embodiment of the present disclosure;

FIG. 6 is a schematic diagram of a principle of an offline mode of a single machine and a plurality of containers scene according to an embodiment of the present disclosure;

FIG. 7 is a schematic diagram of a principle of a deployment architecture of a host in an offline mode of a single machine and a plurality of containers scene according to an embodiment of the present disclosure;

FIG. 8 is a schematic diagram of a principle of a deployment architecture of an offline mode of a cluster scene according to an embodiment of the present disclosure;

FIG. 9 is a schematic diagram of a method of running an application according to an embodiment of the present disclosure;

FIG. 10 is a schematic flowchart of a method of running an application according to an embodiment of the present disclosure;

FIG. 11 is a schematic block diagram of a structure of an apparatus of running an application according to an embodiment of the present disclosure;

FIG. 12 is a schematic block diagram of a structure of an apparatus of running an application according to an embodiment of the present disclosure;

FIG. 13 is a schematic flowchart of a method of running an application according to an embodiment of the present disclosure;

FIG. 14 is a schematic flowchart of a method of running an application according to an embodiment of the present disclosure;

FIG. 15 is a schematic diagram of a principle of an offline mode according to an embodiment of the present disclosure;

FIG. 16 is a schematic flowchart of a method of running an application according to an embodiment of the present disclosure;

FIG. 17 is a schematic flowchart of a method of running an application according to an embodiment of the present disclosure;

FIG. 18 is a schematic diagram of a principle of an online mode according to an embodiment of the present disclosure; and

FIG. 19 is a block diagram of an electronic device applicable to implement a method of running an application according to an embodiment of the present disclosure.

### DETAILED DESCRIPTION OF EMBODIMENTS

In order to make purposes, technical solutions and advantages of embodiments of the present disclosure clearer, technical solutions in some embodiments of the present disclosure will be described clearly and completely in combination with accompanying drawings. Obviously, the described embodiments are only part of the embodiments of the present disclosure, not all of them. Based on the embodiments of the present disclosure provided, all other embodiments obtained by those of ordinary skill in the art without creative labor, fall within the scope of protection of the present disclosure. It should be noted that, throughout the accompanying drawings, the same elements are represented by the same or similar references signs. In the following description, some specific embodiments are only for descriptive purposes and should not be understood as limiting the present disclosure, but rather as examples of the embodiments of the present disclosure. When it may cause confusion in understanding of the present disclosure, conventional structures or configurations will be omitted. It should be noted that a shape and size of each component in the drawings do not reflect the true size and proportion, but only represent contents of the embodiments of the present disclosure.

Unless otherwise defined, the technical or scientific terms used in the embodiments of the present disclosure shall have the usual meaning understood by those of ordinary skill in the art. The terms “first”, “second”, and similar terms used in the embodiments of the present disclosure do not indicate any order, quantity, or importance, but are only used to distinguish different components.

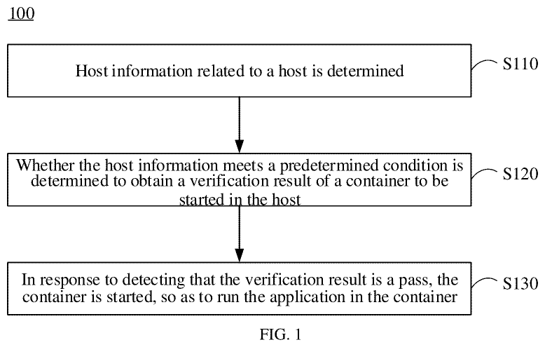

FIG. 1 is a schematic flowchart of a method of running an application according to an embodiment of the present disclosure.

As shown in FIG. 1, the present disclosure provides a method 100 of running an application. The method 100 may be implemented by a host. The method 100 may include operation S110 to operation S130.

In operation S110, host information related to a host is determined.

For example, the host may include a physical machine or may also include a virtual machine. The host may store at least one container image locally. At least one container may be created by using a single container image, and at least one application may be run in the container.

For example, the host information may include a device identifier or may also include information such as a container image identifier in the host.

In operation S120, whether the host information meets a predetermined condition is determined to obtain a verification result of a container to be started in the host.

For example, the predetermined condition may include that a device identifier of the host is in a predetermined device identifier list, or may also include that a container image identifier of the host is in a predetermined image identifier list.

For example, the verification result may include a pass and a fail. It is possible to determine that the verification result is a pass in a case that the host information meets the predetermined condition, otherwise it is determined that the verification result is a fail.

In operation S130, in response to detecting that the verification result is a pass, the container is started, so as to run the application in the container.

It may be understood that in some embodiments, if the verification result is a fail, the container may be stopped starting, thereby avoiding running the application in the container.

According to the technical solution provided in the embodiments of the present disclosure, the verification result is first determined according to the host information and the predetermined condition. In a case that the verification result is a pass, the application is run. If there are problems such as the application is stolen or copied, the verification result may be a fail, and the application may not be run, thereby protecting the application in the container, alleviating the problem of the application being copied or stolen, and protecting the rights and interests of application developers. In addition, the method provided in the embodiments of the present disclosure is implemented by software and does not rely on hardware, and the costs are low. Moreover, there is no need to deploy a separate service on the host, it is possible to recognize by running the container directly, and the deployment is convenient.

The following is an explanation of the host information and the predetermined condition.

In an example, the host information may include a device fingerprint information of the host. Accordingly, the predetermined condition may include a fingerprint sub-condition. For example, the fingerprint sub-condition may include that a fingerprint record is consistent with device fingerprint information. The fingerprint record may be pre-recorded locally or stored in a cloud in advance. The fingerprint record records device fingerprint information of a legal device. In a case that the host is online, it is possible to compare whether the device fingerprint information is consistent with the fingerprint record stored in the cloud or the local storage of the host. In a case that the host is offline, it is possible to compare whether the device fingerprint information is consistent with the fingerprint record stored in the local storage of the host. In this example, the device fingerprint may be verified, so as to determine whether the host is legal.

For example, the device fingerprint information may be determined according to at least one of a host identifier, disk information, mainboard information, CPU information and network card information. For example, the CPU information may include CPU supplier information, CPU quantity, etc. The network card information may include network card address. The disk information may include a disk identifier. The mainboard information may include a mainboard identifier. For example, an initial string may be determined according to at least one of the host identifier, the disk information, the mainboard information, the CPU information and the network card information. For example, a certain device information may be determined as the initial string, or a plurality of device information may be combined in a predetermined order to form the initial string. Next, the initial string may be encrypted to obtain the device fingerprint information. The encryption methods may include symmetric encryption and asymmetric encryption, such as using sha256 encryption algorithm for encryption. In this example, the initial string is encrypted to improve the security of the device fingerprint information. For another example, the initial string may not be encrypted, and the initial string may be directly used as the device fingerprint information. In this example, encryption operations are omitted, so that there is no need for subsequent decryption processing, thereby improving data processing efficiency.

In another example, the host information may include an authorization validity period of the host. Accordingly, the predetermined condition may include a validity period sub-condition. For example, the validity period sub-condition may include that the authorization validity period is in a valid state. In an actual verification process, the validity period may be pre-recorded in the local storage or stored in the cloud. In a case that the host is online, it is possible to compare whether the authorization validity period is consistent with the validity period stored in the cloud or the local storage of the host. In a case that the host is offline, it is possible to compare whether the authorization validity period is consistent with the validity period stored in the local storage of the host. In this example, the authorization validity period of the host may be verified, so as to avoid running protected applications by the legal but expired host.

In another example, the host information may include a first image information of a container image in the host. Accordingly, the predetermined condition may include an image sub-condition. For example, the image sub-condition may include that a second image information in a configuration file is consistent with the first image information. The first image information may include at least one of an image identifier and an image version number of the container image in the host. Similarly, the second image information may include at least one of an image identifier and an image version number in the configuration file. The image identifier may include an image name. In this example, the image information may be verified, so as to avoid using illegal image to create the container by the host.

In another example, the host information may include a number of containers that have been started in the host. Accordingly, the predetermined condition may include a quantitative sub-condition. For example, the quantitative sub-condition may include that the number of containers that have been started is less than a quantitative threshold. In this example, the number of containers may be verified, so as to avoid the number of containers run by the host exceeding a quantitative limit.

In some embodiments, the host information may include only one sub-information of the plurality of sub-information mentioned above. Accordingly, the predetermined condition may include only one sub-condition corresponding to the one sub-information.

In some other embodiments, the host information may include a plurality of sub-information. Accordingly, the predetermined condition includes a plurality of sub-conditions respectively corresponding to the plurality of sub-information. For example, the host information may include a number of containers that have been started in the host, first image information of a container image in the host, device fingerprint information of the host and an authorization validity period of the host. Accordingly, the predetermined condition may include a quantitative sub-condition, an image sub-condition, a fingerprint sub-condition and a validity period sub-condition.

It should be noted that when the host information includes the plurality of sub-information and the predetermined condition includes the plurality of sub-conditions, it may be determined whether the plurality of sub-information meet respective corresponding sub-conditions. It may be determined that the verification result is a pass, in a case that all the sub-information meet the corresponding sub-conditions, otherwise the verification result is a fail, so as to comprehensively verify the host information of the host to ensure the security of the application in the container in the host. Alternatively, it may be determined that the verification result is a pass, in a case that a certain sub-information meets the corresponding sub-condition, otherwise the verification result is a fail. It should be noted that the embodiment does not limit the order of determining whether the plurality of sub-information meet respective corresponding sub-conditions.

In an actual deployment process, the method of running an application provided in the embodiments of the present disclosure is applicable to different scenes such as single machine and single container, single machine and a plurality of containers, container cluster, etc., and has a wide range of applications. In each scene, both online mode and offline mode are supported, and authorization is more convenient. It should be noted that in the offline mode, the host may not interact with a credit platform. In the online mode, the host needs to interact with the credit platform. The following is an explanation of the credit platform.

The credit platform may include storage units, processors, etc. In physical deployment, the credit platform may be deployed on a single server, for example, may be deployed on a host node or a container node, or may be deployed on other servers independent of the host. The credit platform may be used to compare whether the acquired sub-information meets the pre-stored sub-condition. The following combined with the embodiments will explain a signature verification process of the credit platform. For example, the host acquires device fingerprint information through a local acquisition program, and then the host may send the device fingerprint information to the credit platform through a form of a data pack. A monitoring function of the credit platform may monitor whether the credit platform has acquired the device fingerprint information from the host. In a case that it is monitored that the credit platform has already acquired the device fingerprint information, the credit platform is triggered to retrieve the fingerprint record pre-stored in the storage unit. Next, the device fingerprint information is compared with the fingerprint record by the processor, so as to achieve the signature verification process described above.

The following is an explanation of a method of running the application in various scenes combined with specific embodiments.

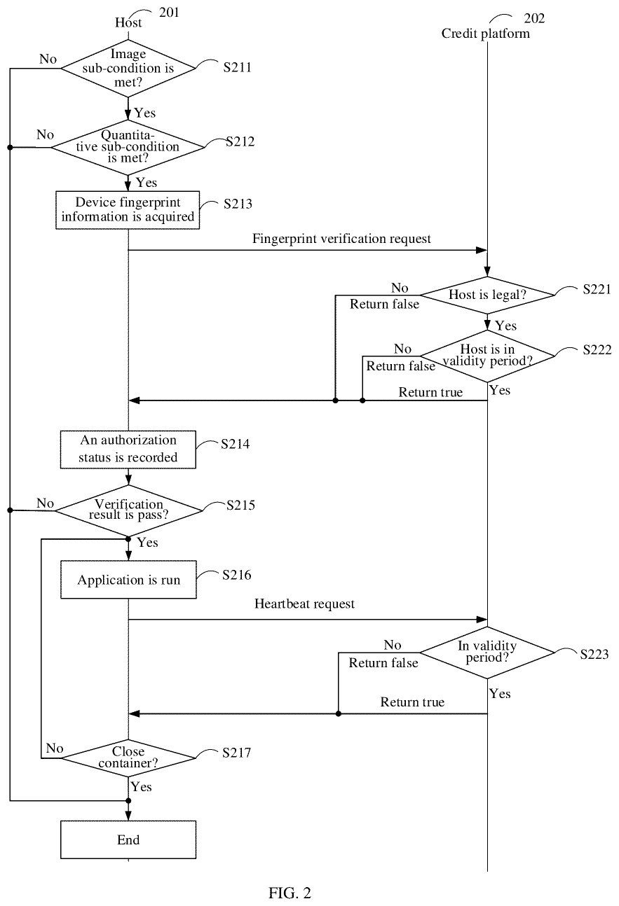

FIG. 2 is a schematic diagram of a principle of an online mode of a single machine and single container scene according to an embodiment of the present disclosure.

With reference to FIG. 2, the following is an explanation of the online mode of the single machine and single container scene. The single machine and single container may represent one host 201 running one protected container, and the host 201 may be a physical machine or may also be a virtual machine.

In operation S211, whether a first image information meets an image sub-condition is determined by the host 201. For example, the first image information in a configuration file is read in a process of starting the container. The predetermined program in the container may be called. The predetermined program may be docker-check-sdk. The predetermined program may read the configuration file and acquire the first image information. The first image information may include an image name and an image version number. Next, the predetermined program may execute a docker command in the host 201 through ssh to achieve interaction between the container and the host 201. Whether a second image information with the same name as the image name exists in the host 201 is checked. If the second image information does not exist, it indicates that the host 201 is illegal and the program may be terminated. If the second image information exists, the next step may be proceeded.

In operation S212, whether the number of containers that have been started in the host 201 meets a quantitative sub-condition is determined. For example, it is possible to check if the container in the host 201 has been started. Due to the single machine and single container scene, the host 201 only supports running one container, and the quantitative threshold may be 1. If the container has already been started, the number of started containers is 1, and the number of started containers does not meet the quantitative sub-condition. Therefore, it is determined that a check status (status) is false. If the container is not started, the next step may be proceeded.

Next, whether device fingerprint information of the host 201 meets the fingerprint sub-condition may be determined by operation S213 and operation S221.

In operation S213, the host 201 acquires device fingerprint information. Next, the host 201 remotely calls a verification interface of the credit platform 202 and sends a fingerprint verification request. The verification interface may be an HTTP interface. The fingerprint verification request includes the device fingerprint information.

In operation S221, the credit platform 202 determines whether the host 201 is legal. For example, after the verification interface of the credit platform 202 receives a fingerprint verification request from the host 201, the credit platform 202 parses the device fingerprint information and compares the parsed device fingerprint information with the fingerprint record recorded in the credit platform 202. If the fingerprint record is consistent with the device fingerprint information, the credit platform 202 determines that the host 201 is legal and returns a first processing result as true to the host 201, or the next step may also be proceeded. If the fingerprint record is not consistent with the device fingerprint information, the credit platform 202 determines that the host 201 is illegal and returns the first processing result as false in the check status (status) to the host 201. It may be seen that, if the host 201 is legal, it indicates that the device fingerprint information meets the fingerprint sub-condition, while if the host 201 is illegal, it indicates that the device fingerprint information does not meet the fingerprint sub-condition. In addition, the above-mentioned fingerprint record includes at least one reference fingerprint information, and it may be determined that the fingerprint record is consistent with the device fingerprint information in a case that the at least one reference fingerprint information includes fingerprint information which is the same as the device fingerprint information.

Next, whether validity period information of the host 201 meets a validity period sub-condition may be determined through operation S222.

In operation S222, the credit platform 202 determines whether the host 201 is in a validity period. For example, the credit platform 202 queries a device service authorization validity period according to the device fingerprint information, compares the validity period with the current time of the credit platform 202. If the validity period is before the current time of the credit platform 202, it indicates that the validity period has expired. The interface may return a second processing result as false in the check status (status) to the host 201, otherwise the second processing result as true in the check status (status) is returned. It may be seen that the second processing result described above indicates whether the authorization validity period is in a valid state.

In operation S214, the host 201 may record an authorization status.

In operation S215, the host 201 determines whether the verification result is a pass. If the verification result is a pass, operation S216 is executed, that is the application is run. If the verification result is a fail, it ends. For example, the host 201 may determine a fingerprint verification sub-result and a validity period verification sub-result based on the first processing result and the second processing result, respectively. For example, if the first processing result is true, it indicates that the fingerprint verification sub-result is a pass, and if the first processing result is false, it indicates that the fingerprint verification sub-result is a fail. If the second processing result is true, it indicates that the validity period verification sub-result is a pass, and if the second processing result is false, it indicates that the validity period verification sub-result is a fail. The host 201 may also determine whether to run the application according to a value returned by the verification interface of the credit platform 202. For example, if the verification interface returns false, it indicates that the service has expired or the device is illegal, and the application may not be run at this time. For example, if the verification interface returns true, the application in the container may be run.

In addition, after starting the container, the validity information of the host 201 may also be verified online, so as to determine whether to close the container. The following is an explanation of a process of online verification through operation S223 and operation S217.

In operation S223, whether the validity period of the host 201 is in a validity period is determined. For example, in the process of running a protected application, the host 201 may call an online verification interface of the credit platform 202 and send a heartbeat request to the online verification interface every predetermined period of time. The predetermined period of time may be 1 hour, and the heartbeat request includes device fingerprint information. The credit platform 202 may determine the validity information indicating whether the authorization validity period of the host 201 is in the valid state according to the device fingerprint information. If the authorization validity period of the host 201 has expired, that is, the authorization validity period of the host 201 is in an invalid state, the credit platform 202 returns the validity information as false to the host 201, otherwise the validity information as true is returned.

In operation S217, the host 201 may determine whether to close the container according to the received validity information. For example, the host 201 may destroy the container and stop running the application in a case of receiving that the validity information is false, and the host 201 may continue running the application in a case of receiving that the validity information is true. In this embodiment, whether the authorization validity period of the host 201 has expired may be verified online in the process of running the application, and whether to close the application is determined based on the result of whether the authorization validity period of the host 201 has expired, thereby avoiding continuing running the application after the authorization validity period of the host 201 has expired.

It should be noted that this embodiment does not limit the order of verifying whether the plurality of sub-information meets respective corresponding sub-conditions. In other embodiments, other verification orders may also be used.

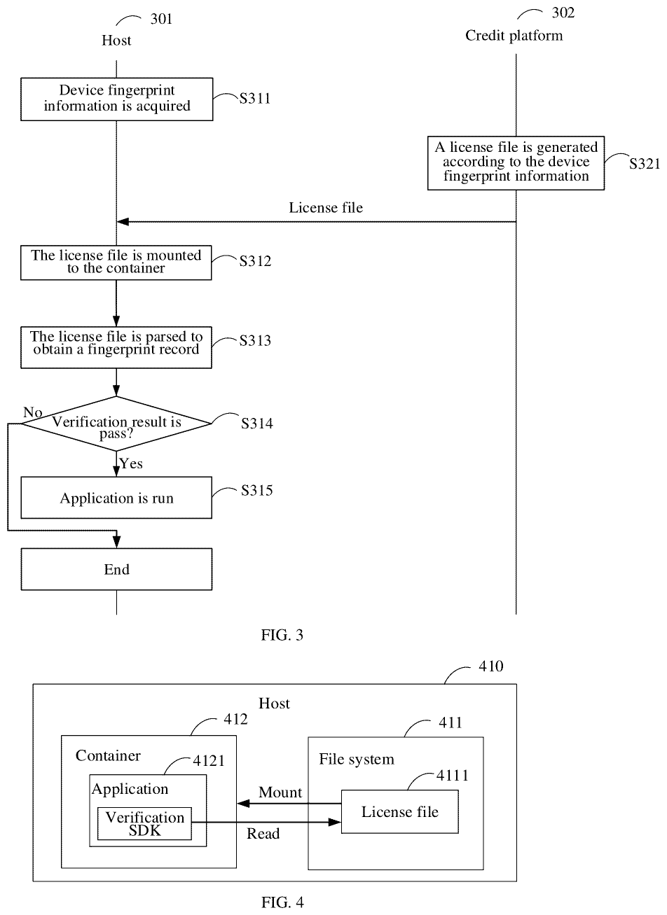

FIG. 3 is a schematic diagram of an offline mode of a single machine and single container scene according to an embodiment of the present disclosure.

The following is an explanation of the offline mode of the single machine and single container scene, combined with FIG. 3.

In operation S311, device fingerprint information of a host 301 is acquired.

In operation S321, the credit platform 302 generates a license file based on the device fingerprint information. For example, the operator manually enters customer information, product information and other information in a front-end interface of the credit platform 302. The product information may include software information to be credited. The operator may also input the device fingerprint information in the front-end interface of the credit platform 302, or the host 301 may send the device fingerprint information to the credit platform 302 when online. The credit platform 302 may generate the license file based on the device fingerprint information. The license file may be, for example, a license file.

In operation S312, the host 301 may mount the license file to the container. For example, the host 301 may download the license file from the credit platform 302 when online and store the license file locally. For example, the host 301 may send a download request to the credit platform 302, and the credit platform 302 may send a license file to the host 301. Next, the host 301 may mount the license file to the container through docker-compose (a tool for single machine and container orchestration).

In operation S313, the host 301 may parse the license file to obtain device fingerprint information in the license file. The device fingerprint information is referred to as a fingerprint record.

In operation S314, the host 301 determines whether a verification result is a pass. If the verification result is a pass, operation S315 is executed; otherwise, it ends.

For example, the host 301 may use the local license file for verification when offline. In the verification process, the host 301 may determine whether the first image information meets the image sub-condition, determine whether the number of containers that have been started in the host 301 meets the quantitative sub-condition, and determine whether the device fingerprint information of the host 301 meets the fingerprint sub-condition. For the determination method, reference may be made to the online mode of the single machine and single capacitor described above, which will not be repeated here in this embodiment.

It should be noted that the difference between this embodiment and the online mode of a single machine and single container is that in the process of determining whether the device fingerprint information of the host 301 meets the fingerprint sub-condition, the host 301 may read the local license file, then parse the license file to obtain the fingerprint record. Next, the host 301 may determine whether the fingerprint record is consistent with the device fingerprint information, to obtain the fingerprint verification sub-result of the verification result. If the fingerprint verification sub-result is a pass, the application is run; otherwise, the processing is ended and the application is not run.

In operation S315, the application is run.

In some embodiments, the offline mode may omit the operation of determining whether the validity period information of the host 301 meets the validity period sub-condition. In some embodiments, the offline mode may determine whether the validity period information of the host 301 meets the validity period sub-condition. In this case, a validity period threshold may be recorded in the license file. The host 301 may acquire the validity period threshold after parsing the license file, thereby determining the validity period verification sub-result.

It should be noted that in some embodiments, the credit platform may encrypt the license file, and the host may decrypt the encrypted license file. For example, the credit platform and the host predetermine the encryption and decryption methods, and then the credit platform encrypts according to the predetermined encryption method, while the host decrypts according to the predetermined decryption method. For example, a combination of symmetric encryption and asymmetric encryption may be used to achieve encryption. The credit platform may generate a symmetric key using a symmetric encryption algorithm, then encrypt the license file using the symmetric key, encrypt the symmetric key mentioned above by a public key in a key pair generated using an asymmetric encryption algorithm, and send the encrypted license file and the encrypted symmetric key to the host. The host may decrypt the encrypted symmetric key using a private key in the key pair, and then decrypt the encrypted license file using the decrypted symmetric key, thereby obtaining the license file. This embodiment may improve the security of the license file through encrypting and decrypting the license file, so as to avoid tampering with the license file and causing errors in determining that the device fingerprint information meets the corresponding sub-conditions, thereby improving the security of the application.

It may be understood that in some other embodiments, the license file may not be encrypted. The credit platform may directly send an un-decrypted license file to the host. Accordingly, the host does not need to decrypt the license file.

FIG. 4 is a schematic diagram of a principle of a deployment architecture of a host in an offline mode of a single machine and single container scene according to an embodiment of the present disclosure.

As shown in FIG. 4, the host 410 includes a file system 411 and a container 412. The application 4121 in the container 412 is the application to be protected. The application 4121 includes a predetermined verification program. The predetermined verification program may be a verification SDK program. The verification SDK program may read the license file 4111 in the file system 411 and perform verification. In this embodiment, the license file 4111 is mounted to the container 412 without the requirement of configuring additional servers, thereby reducing hardware costs.

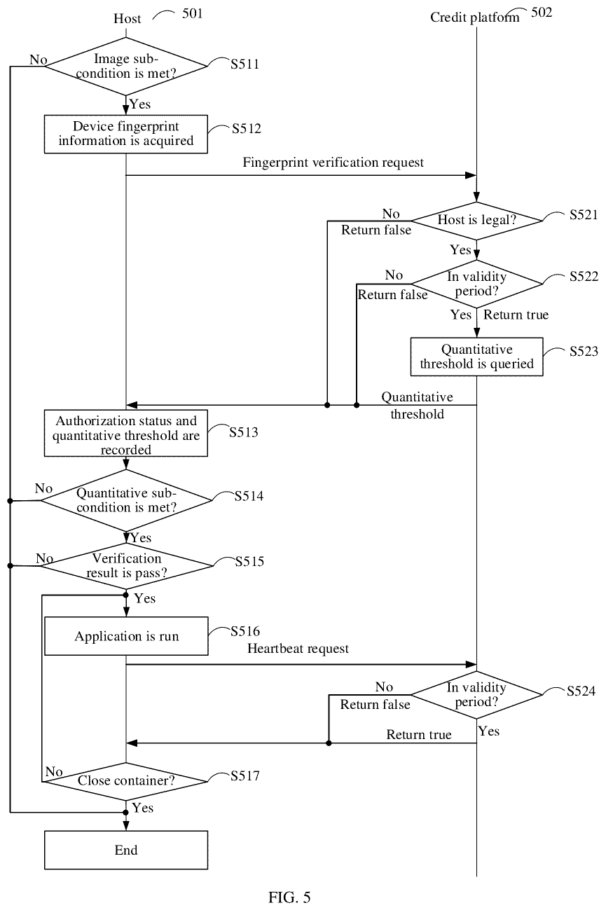

FIG. 5 is a schematic diagram of a principle of a deployment architecture of a host of an online mode of a single machine and a plurality of containers scene according to an embodiment of the present disclosure.

The following is an explanation of the online mode of the single machine and a plurality of containers scene combined with FIG. 5. The single machine and single container may represent a host 501 running a plurality of protected containers.

In this embodiment, the method of running the application involves the host 501 and the credit platform 502. The method may include operation S511 to operation S517 and operation S521 to operation S524.

The host 501 performs the operation S511 to the operation S517. For these operations, reference may be made to the operation S211 to the operation S217 in the online mode of the single machine and single container in the foregoing descriptions, which will not be repeated here in this embodiment. Based on these operations, the host 501 may determine whether the first image information meets the image sub-condition, determine whether the number of containers that have been started in the host 501 meets the quantitative sub-condition, determine whether the device fingerprint information of the host 501 meets the fingerprint sub-condition, and determine whether the validity period information of the host 501 meets the validity period sub-condition.

The credit platform 502 performs the operation S521 to the operation S524. For the operation S521, operation S522 and operation S524, reference may be made to the operation S221 to the operation S223 in the foregoing descriptions, which will not be repeated here in this embodiment.

It should be noted that the difference between this embodiment and the online mode of the single machine and single container is that in the process of determining whether the number of containers that have been started in the host 501 meets the quantitative sub-condition, the credit platform 502 may perform operation S523 after receiving a fingerprint verification request, that is, based on the device fingerprint information in the fingerprint verification request, query the pre-authorized quantitative threshold of the host 501, and return the quantitative threshold to the host 501. Accordingly, the host 501 may detect the number of containers that have been started, and it may be seen that the number of containers does not include the container currently to be started. If the number of containers that have been started is equal to the quantitative threshold, it indicates that the number of containers that have been started has reached an authorized upper limit. Therefore, the container to be started will not be started again, otherwise the container to be started may be started.

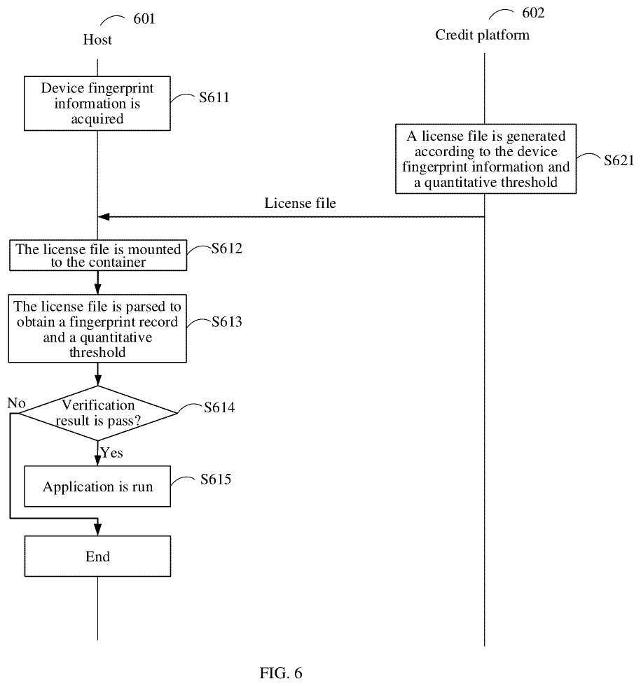

FIG. 6 is a schematic diagram of a principle of an offline mode of a single machine and a plurality of containers scene according to an embodiment of the present disclosure.

The following is an explanation of the offline mode of the single machine and a plurality of containers scene, combined with FIG. 6.

In this embodiment, the method of running the application involves the host 601 and the credit platform 602. The method may include operation S611 to operation S615 and operation S621. The host 601 performs operation S611 to operation S615. For these operations, reference may be made to operation S311 to operation S315 in the offline mode of the single machine and single container in the foregoing descriptions, which will not be repeated here in this embodiment. The credit platform 602 performs operation S621, for which reference may be made to operation S321 in the offline mode of the single machine and single container in the foregoing descriptions, which will not be repeated here in this embodiment.

It should be noted that the difference between this embodiment and the offline mode in the single machine and single container scene is that a quantitative threshold may be recorded on the credit platform 602, and the quantitative threshold may be recorded in the license file in the process of generating the license file by the credit platform 602. Accordingly, the host 601 may acquire the quantitative threshold from the license file after parsing the license file.

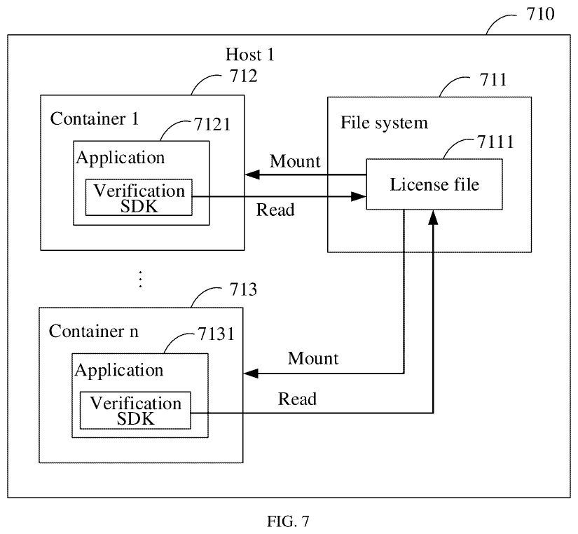

FIG. 7 is a schematic diagram of a principle of a deployment architecture of a host of an offline mode for a single machine and a plurality of containers scene according to an embodiment of the present disclosure.

As shown in FIG. 7, the host 710 includes a file system 711 and n containers, where n is an integer greater than or equal to 2. The applications in the containers are applications to be protected. The applications include predetermined verification programs. A license file 7111 is mounted to n containers, and the predetermined verification program of each container may read the license file 7111. For example, the n containers include container 1 712, . . . , container n 713. An application 7121 may be run in the container 1 712, and an application 7131 may be run in the container n 713. The applications in the n containers may be the same or different.

The following is an explanation of an online mode and an offline mode of a cluster scene. The cluster scene includes a plurality of hosts. The plurality of hosts may belong to a same cluster. Each host may deploy one container or may deploy a plurality of containers.

In practical applications, a container cluster may be used in some large and complex scenes, such as smart transportation, smart banking, etc., especially in smart park. In the smart park, due to the complexity of the Internet environment, the variety of functional requirements, the large amount of data involved and other reasons, the processing capacity of a single physical machine, a virtual machine and other stand-alone devices may not meet the requirements of the use, so that a cluster formed by a plurality of devices is required to provide higher processing capacity. It may be understood that due to spatial distance limitations and other reasons in large industrial parks, the security of using physical device interfaces in a plurality of real-world scenes is relatively low. By adopting the method provided in the embodiments of the present disclosure, the application may be run more safely, concisely and efficiently.

For the online mode of the cluster scene, reference may be made to the online mode of the single machine and single container or the online mode of the single machine and a plurality of containers, and each host in the cluster scene may be verified separately.

For the offline mode in the cluster scene, reference may be made to the online mode of the single machine and single container or the offline mode of the single machine and a plurality of containers, and each host in the cluster scene may be verified separately.

For the offline mode in cluster scenes, the following is an explanation of another implementation method for the offline mode of the single machine and a plurality of containers scene.

The difference between this embodiment and the offline mode of the cluster scene described above is that this embodiment may acquire a device fingerprint information list of various hosts in the cluster. The device fingerprint information list may be used as a fingerprint record. The credit platform may generate a license file based on the device fingerprint information list and a quantitative threshold of each host. The license file may be stored in the local storage of each host in the cluster and mounted to the containers. The host parses the license file to obtain the device fingerprint information list and the quantitative threshold of each host.

In the process of determining whether the device fingerprint information of the host meets the fingerprint sub-condition, it may be determined whether the device fingerprint information of the host exists in the device fingerprint information list. If so, it is determined that the fingerprint record is consistent with the device fingerprint information; otherwise, it is determined that the fingerprint record is inconsistent with the device fingerprint information.

In some embodiments, the credit platform may encrypt the device fingerprint information list mentioned above. Accordingly, the host may decrypt the encrypted device fingerprint information list. In addition, in the actual encryption process, the complete device fingerprint information list may be encrypted and decrypted as a whole, or each device fingerprint information in the device fingerprint information list may be separately encrypted and separately decrypted, thereby increasing the difficulty of verifying whether the device fingerprint information is consistent with the fingerprint record, increasing the difficulty of stealing the application in the host, and further improving the security of the application. For the encryption and decryption methods in this embodiment, reference may be made to the foregoing descriptions, which will not be repeated in this embodiment.

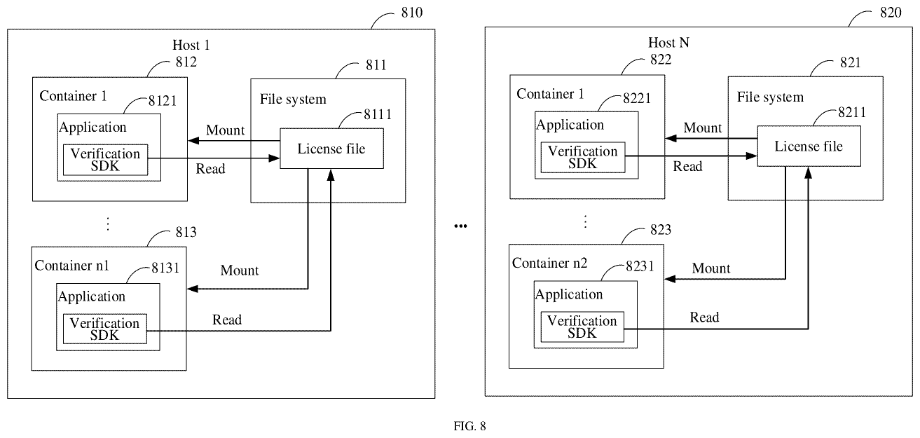

FIG. 8 is a schematic diagram of a principle of a deployment architecture of an offline mode of a cluster scene according to an embodiment of the present disclosure.

As shown in FIG. 8, the cluster includes N hosts, where N is an integer greater than or equal to 2, and each host may include at least one container. License files in the N hosts may be the same. For a same host, the license file in the host may be mounted to a plurality of containers in the host, and the plurality of containers may read the license file. For example, the cluster includes host 1 810, . . . , host N 820, where the host 1 810 may include n1 containers, the container 1 812 and the container n1 813 may run applications 8121 and 8131 respectively. The file system 811 includes a license file 8111, and applications in each container of the host 1 810 may read the license file 8111. Similarly, the host N 820 may include n2 containers, where the container 1 822 and the container n2 823 may run applications 8221 and 8231 respectively. The file system 821 includes a license file 8211, and applications in each container of the host N 820 may read the license file 8211. The above n1 and n2 are integers greater than or equal to 1.

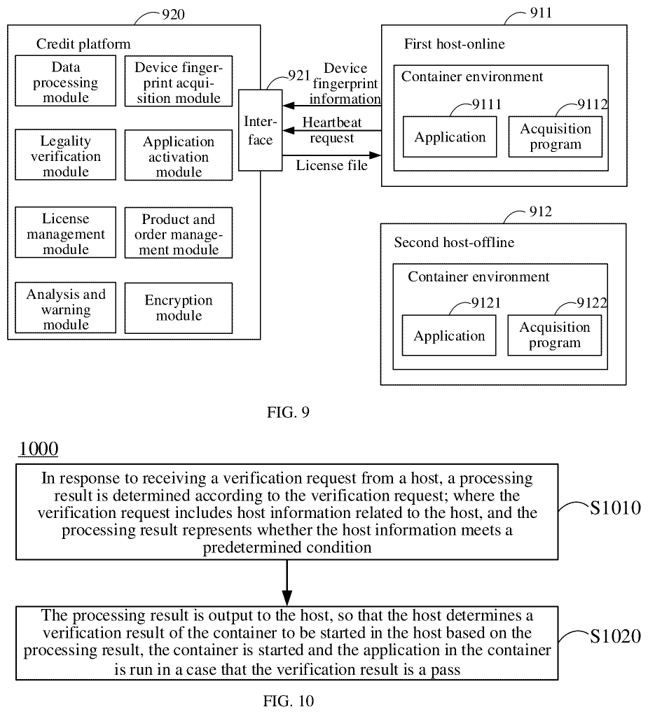

FIG. 9 is a schematic diagram of a principle of a method of running an application according to an embodiment of the present disclosure.

This embodiment involves a credit platform 920, at least one first host 911 and at least one second host 912.

The credit platform 920 may include a plurality of functional modules, such as a data processing module, a legality verification module, a license management module, an analysis and warning module, a device fingerprint acquisition module, an application activation module, a product and order management module, an encryption module, etc. The following is an explanation of various functional modules in the credit platform 920.

The data processing module may be used to process data to be analyzed, so as to obtain an analysis result. The data to be analyzed may include business distribution information of the application, industry distribution information of the application, etc.

The legality verification module is used to perform online legitimacy verification in a case that the first host 911 is in an online mode. For example, it is possible to compare whether the device fingerprint information is consistent with the pre-stored fingerprint records, or to compare whether the authorization validity period of the host is within a validity period range.

The license management module is used to manage the license file, such as managing a validity period of license file, a corresponding relationship between the license file and the first host 911, etc. The license management module is also used to generate a license file and issue the license file to the first host 911.

The analysis and warning module is used for event warning. For example, when the validity period of a certain device is about to expire, the analysis warning module may output warning information to remind the device that the validity period is approaching.

The device fingerprint acquisition module may include an acquisition program for acquiring device fingerprint information. The acquisition program may be issued by the credit platform 920 to the first host 911 and the second host 912. The first host 911 and the second host 912 may respectively run local acquisition program 9112 and local acquisition program 9122 to determine respective own device fingerprint information. The acquisition program 9112 and the acquisition program 9122 may be the same or different.

The application activation module may include a decryption program for decrypting the license file. The decryption program may be issued by the credit platform 920 to the first host 911. The first host 911 may run a local decryption program to decrypt the license file.

The product and order management module is used to manage order information, for example, may manage users, products, expiration dates and other information of orders. The product and order management module may be also used to manage product information. The product may be the protected applications mentioned above, for example, information such as application versions may be managed.

The encryption module is used to encrypt the license file.

The number of first host 911 is at least one. It may be seen that when a plurality of first hosts 911 are provided, these first hosts 911 form a first cluster. The first host 911 is in an online state, and the first host 911 includes a container environment. The container environment may include a protected application 9111, and may also include an acquisition program 9112. The first host 911 may download the acquisition program 9112 from the credit platform 920. The acquisition program 9112 may, for example, determine device fingerprint information according to at least one of a first host identifier, disk information, mainboard information, CPU information and network card information.

The credit platform 920 may interact with the first host 911 through an interface 921. For example, the first host 911 may send device fingerprint information to the interface 921 of the credit platform 920, and the credit platform 920 may return a processing result obtained based on the device fingerprint information to the first host 911. The credit platform 920 may send a license file to the first host 911, and the first host 911 may send a heartbeat request to the interface 921.

Similarly, the number of the second host 912 is at least one. It may be seen that when a plurality of second hosts 912 are provided, these second hosts 912 form a second cluster. The second host 912 is in an offline state, and the second host 912 includes a container environment. The container environment may include a protected application 9121, and may also include an acquisition program 9122. The second host 912 may download the acquisition program 9122 from the credit platform 920. The second host 912 may download the license file from the credit platform 920 in advance through the interface 921, and perform verification based on the license file under the offline mode.

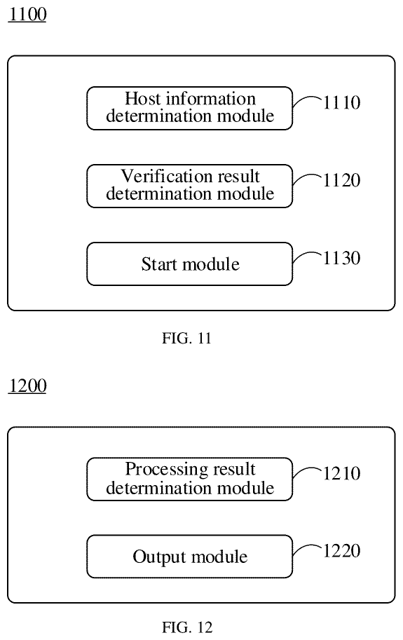

FIG. 10 is a schematic flowchart of a method of running an application according to an embodiment of the present disclosure.

As shown in FIG. 10, the method 1000 in this embodiment may be implemented by the credit platform. The method 1000 may include operation S1010 to operation S1020.

In operation S1010, in response to receiving a verification request from a host, a processing result is determined according to the verification request; where the verification request includes host information related to the host, and the processing result represents whether the host information meets a predetermined condition.

In operation S1020, the processing result is output to the host, so that the host determines a verification result of the container to be started in the host based on the processing result, the container is started and the application in the container is run in a case that the verification result is a pass.

For example, the above verification request may include the fingerprint verification request mentioned above. The credit platform may determine at least one of a first processing result and a second processing result according to the device fingerprint information in the verification request. For the first processing result and the second processing result, reference may be made to the foregoing descriptions, which will not be repeated here. Accordingly, after the credit platform outputs the processing result to the host, the host may determine a fingerprint verification sub-result based on the first processing result, and may also determine a validity verification sub-result based on the second processing result.

The technical solution provided in this embodiment may protect the applications in the container, alleviate the problem of applications being copied or stolen, and protect the rights and interests of application developers.

FIG. 11 is a schematic diagram of a structure of an apparatus of running an application according to an embodiment of the present disclosure.

As shown in FIG. 11, the apparatus 1100 of running the application may include a host information determination module 1110, a verification result determination module 1120 and a start module 1130.

The host information determination module 1110 is used to determine host information related to a host.

The verification result determination module 1120 is used to determine whether the host information meets a predetermined condition to obtain a verification result of a container to be started in the host.

The startup module 1130 is used to start the container in response to detecting that the verification result is a pass, so as to run the application in the container.

According to another embodiment of the present disclosure, the host information includes at least one sub-information selected from: a number of containers that have been started in the host, first image information of a container image in the host, device fingerprint information of the host and an authorization validity period of the host. The predetermined condition includes at least one of: a quantitative sub-condition corresponding to the number of containers, an image sub-condition corresponding to the first image information, a fingerprint sub-condition corresponding to the device fingerprint information and a validity period sub-condition corresponding to the authorization validity period. The verification result determination module includes a sub-result determination sub-module and a verification result determination sub-module. The sub-result determination sub-module is used to determine whether at least one sub-information meets respective corresponding sub-condition to obtain at least one verification sub-result corresponding to the at least one sub-information. The verification result determination sub-module is used to determine the verification result according to the at least one verification sub-result.

According to another embodiment of the present disclosure, the fingerprint sub-condition includes that the fingerprint record is consistent with the device fingerprint information.

According to another embodiment of the present disclosure, the sub-result determination sub-module includes a verification request sending unit and a fingerprint verification sub-result determination unit. The verification request sending unit is used to send a fingerprint verification request including device fingerprint information to the credit platform in a case that the host is in an online state, so that the credit platform may determine a first processing result representing whether the fingerprint record is consistent with the device fingerprint information. The fingerprint verification sub-result determination unit is used to determine a fingerprint verification sub-result of the verification result according to the first processing result in response to receiving the first processing result from the credit platform.

According to another embodiment of the present disclosure, the sub-result determination sub-module includes a reading unit, a parsing unit, and a fingerprint verification sub-result determination unit. The reading unit is used to read a local license file in a case that the host is in an offline state. The license file is acquired from the credit platform. The parsing unit is used to parse the license file to obtain a fingerprint record. The fingerprint verification sub-result determination unit is used to determine whether the fingerprint record is consistent with the device fingerprint information to obtain a fingerprint verification sub-result of the verification result.

According to another embodiment of the present disclosure, the fingerprint verification sub-result determination unit includes: a first determination sub-unit and a second determination sub-unit. The first determination sub-unit is used to determine that the fingerprint record is consistent with the device fingerprint information in response to detecting that the fingerprint record includes fingerprint information of a host, and the fingerprint information of the host is the same as the device fingerprint information. The second determination sub-unit is used to determine that the fingerprint record is consistent with the device fingerprint information, in response to detecting that the fingerprint record includes a plurality of reference fingerprint information in a plurality of hosts in a cluster and the plurality of reference fingerprint information include reference fingerprint information which is the same as the device fingerprint information. The cluster refers to the cluster in which the host is located.

According to another embodiment of the present disclosure, the validity period sub-condition includes that the authorization validity period is in a valid state.

According to another embodiment of the present disclosure, the sub-result determination sub-module includes a verification request sending unit and a validity period verification sub-result determination unit. The verification request sending unit is used to send a fingerprint verification request including device fingerprint information to the credit platform in a case that the host is in an online state, so that the credit platform may determine a second processing result representing whether the authorization validity period is in a valid state. The validity verification sub-result determination unit is used to determine a validity verification sub-result of the verification result according to the second processing result in response to receiving the second processing result from the credit platform.

According to another embodiment of the present disclosure, the image sub-condition includes that second image information in a configuration file is consistent with the first image information.

According to another embodiment of the present disclosure, the first image information includes at least one of an image identifier and an image version number.

According to another embodiment of the present disclosure, the quantitative sub-condition includes that the number of the containers that have been started is less than a quantitative threshold.

According to another embodiment of the present disclosure, the host information includes at least two sub-information, and the predetermined condition includes at least two sub-conditions. The verification result determination sub-module includes a first verification result determination unit and a second verification result determination unit. The first verification result determination unit is used to determine that the verification result is the pass, in response to detecting that each verification sub-result of at least two verification sub-results is the pass. The second verification result determination unit is used to determine that the verification result is a fail, in response to detecting that the at least two verification sub-results include a failed verification sub-result.

According to another embodiment of the present disclosure, the above-mentioned apparatus further includes a device fingerprint information determination module used to determine device fingerprint information according to at least one of a host identifier, disk information, mainboard information, CPU information and network card information.

According to another embodiment of the present disclosure, the device fingerprint information determination module includes a string determination sub-module and an encryption sub-module. The string determination sub-module is used to determine an initial string according to at least one of the host identification, the disk information, the mainboard information, the CPU information and the network card information. The encryption sub-module is used to encrypt the initial string to obtain device fingerprint information.

According to another embodiment of the present disclosure, the above apparatus further includes a heartbeat request sending module used to send a heartbeat request including device fingerprint information to the credit platform every predetermined period of time in a case that the host is in an online state after starting the container, so that the credit platform determines validity information representing whether an authorization validity period of the host is in a valid state. The status determination module is used to determine whether to close the container according to the validity information in response to receiving the validity information from the credit platform.

According to another embodiment of the present disclosure, the above-mentioned apparatus further includes a stop module used to stop starting the container in response to detecting that the verification result is a fail.

FIG. 12 is a schematic diagram of a structure of an apparatus of running an application according to an embodiment of the present disclosure.

As shown in FIG. 12, the apparatus 1200 of running the application may include a processing result determination module 1210 and an output module 1220.

The processing result determination module 1210 is used to determine, in response to receiving a verification request from a host, a processing result according to the verification request. The verification request includes host information related to the host. The processing result represents whether the host information meets a predetermined condition.

The output module 1220 is used to output the processing result to the host, so that the host determines a verification result of a container to be started in the host based on the processing result, and starts the container and runs the application in the container in a case that the verification result is a pass.

According to another embodiment of the present disclosure, the host information includes device fingerprint information of the host. The processing result includes at least one of: a first processing result representing whether a fingerprint record is consistent with the device fingerprint information, and a second processing result representing whether an authorization validity period of the host is in a valid state. The verification result includes at least one of: a fingerprint verification sub-result and a validity verification sub-result.

According to another embodiment of the present disclosure, the above-mentioned apparatus further includes: a validity information determination module and a validity information sending module. The validity information determination module is used to determine validity information representing whether the authorization validity period of the host is in a valid state according to the device fingerprint information in the heartbeat request in response to receiving a heartbeat request from the host. The validity information sending module is used to send the validity information to the host, so that the host determines whether to close the container according to the validity information.

According to another embodiment of the present disclosure, the above-mentioned apparatus further includes a license file sending module used to send a license file to the host, in response to receiving a download request from the host, so that the host reads and parses the local license file to obtain a fingerprint record in a case that the host is in an offline state, and determine whether the fingerprint record is consistent with the device fingerprint information in the host information to obtain a fingerprint verification sub-result of the verification result.

In practice, there may be a large number of applications (e.g., core algorithms) running on terminal devices that need to be protected. Different from servers, there may be a large number of terminal devices, and it is not practical to acquire fingerprint of each terminal device in advance. In this case, the terminal device may activate the application through an authorization code issued by a platform and the device fingerprint. The method of running the application will be described below in conjunction with specific embodiments.

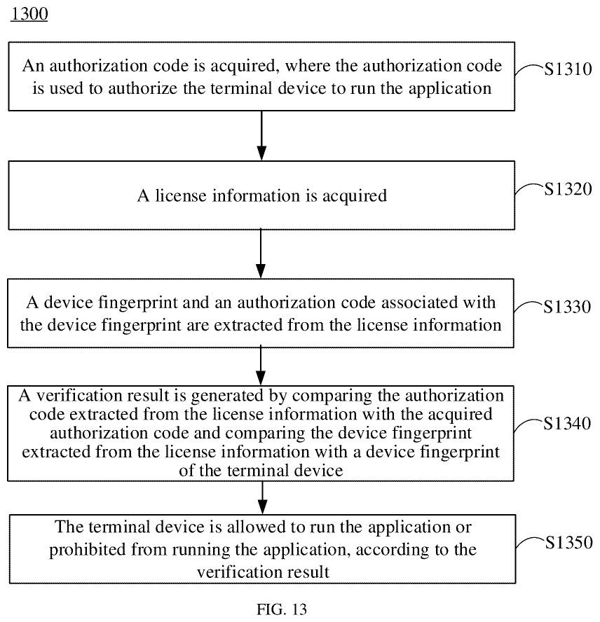

FIG. 13 is a schematic flowchart of a method of running an application according to an embodiment of the present disclosure.

As shown in FIG. 13, the present disclosure provides a method 1300 of running an application, and the method 1300 may be performed by a terminal device. The method 1300 may include operation S1310 to operation S1350.

In operation S1310, an authorization code is acquired, where the authorization code is used to authorize the terminal device to run the application.

For example, the terminal device may include various types of electronic devices, including but not limited to a mobile phone, a tablet computer, a mobile box, etc. The terminal device may have android, IOS, Linux or windows system. The terminal device may be installed with various applications, such as knowledge reading applications, web browser applications, search applications, instant messaging tools, email clients and/or social platform software, etc. (just for example). The terminal device may interact with a server to receive or send information.

In operation S1320, a license information is acquired.

In operation S1330, a device fingerprint and an authorization code associated with the device fingerprint are extracted from the license information.

In operation S1340, a verification result is generated by comparing the authorization code extracted from the license information with the acquired authorization code and comparing the device fingerprint extracted from the license information with a device fingerprint of the terminal device.

The license information in this embodiment is similar to the license file described above, except that the license information in this embodiment further includes an authorization code associated with the device fingerprint in addition to the device fingerprint. The terminal device may verify the device fingerprint and the authorization code respectively. For example, if the authorization code extracted from the license information is consistent with the acquired authorization code and the device fingerprint extracted from the license information is consistent with the device fingerprint of the terminal device, the verification result is a pass, or otherwise the verification result is a fail.

In operation S1350, the terminal device is allowed to run the application or prohibited from running the application, according to the verification result.

It may be understood that the terminal device is allowed to run the application if the verification result is a pass, while the terminal device may be prohibited from running the application, for example, by prompting that the terminal device is not authorized and closing the application, if the verification result is a fail.

According to the technical solution provided in the embodiments of the present disclosure, both the device fingerprint of the terminal device and the authorization code acquired by the terminal device are used in the process of determining the verification result. In a case that the verification result is a pass, the application may be run. If there are problems such as the application is stolen or copied, the verification result may be a fail, and the application may not be run, thereby protecting the application, alleviating the problem of the application being copied or stolen, and protecting the rights and interests of application developers.

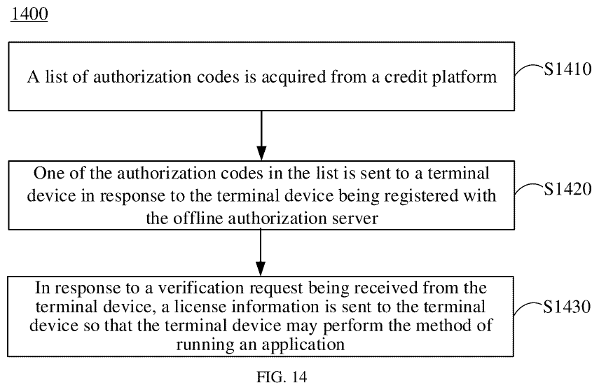

FIG. 14 is a schematic flowchart of a method of running an application according to an embodiment of the present disclosure.

As shown in FIG. 14, the present disclosure provides a method 1400 of running an application, and the method 1400 may be performed by an offline authorization server. The method 1400 may include operation S1410 to operation S1430.

In operation S1410, a list of authorization codes is acquired from a credit platform.

For example, the credit platform may include storage units, processors, etc. In physical deployment, the credit platform may be deployed on a single server, for example, may be deployed on a host node or a container node, or may be deployed on other servers independent of the host.

In some embodiments, the list of authorization codes may be generated by the credit platform according to the number of devices to be authorized. For example, if the number of devices to be authorized for an application is 1,000, the credit platform may generate 1,000 different authorization codes according to a random algorithm and record these authorization codes in a list corresponding to the application. For example, each application may correspond to one or more authorization codes, and if a terminal device receives an authorization code corresponding to the application, the terminal device is authorized to run the application.

In operation S1420, one of the authorization codes in the list is sent to a terminal device in response to the terminal device being registered with the offline authorization server.

For example, in response to the terminal device being registered with the offline authorization server, the offline authorization server may select an authorization code from the list of authorization codes, send the authorization code to the terminal device, and associate the authorization code with the terminal device. Before sending the authorization code to the terminal device, the offline authorization server may select, from the list of authorization codes, an authorization code that has not been associated with any other terminal device, to send to the terminal device.

In operation S1430, in response to a verification request being received from the terminal device, a license information is sent to the terminal device so that the terminal device may perform the method described above.

In some embodiments, the device fingerprint of the terminal device may be carried in the verification request sent by the terminal device. The offline authorization server may find an authorization code associated with the device fingerprint from the list of authorization codes according to the received device fingerprint, and generate a license information based on the found authorization code and the device fingerprint. The terminal device may then verify based on the license information. For example, if the authorization code in the license information is consistent with the authorization code acquired by the terminal device during registration and the device fingerprint in the license information is consistent with the device fingerprint of the terminal device, then the verification passes, or otherwise the verification fails. In some embodiments, in addition to including the device fingerprint and the authorization code, the license information may further include application information associated with the authorization code (for example, one authorization code may be associated with a plurality of application information). If the device fingerprint and the authorization code of the terminal device are consistent with the device fingerprint and the authorization code in the license information, and the information of the application to be run by the terminal device is also consistent with one of a plurality of application information in the license information, then the verification passes, or otherwise the verification fails.

Certainly, the embodiments of the present disclosure are not limited to this, and other methods may be used to generate the license information.

For example, the information of the application to be run may be carried in a verification request sent by the terminal device, and the offline authorization server may find one or more authorization codes corresponding to the information of the application from the list of authorization codes and find the device fingerprint associated with each authorization code. The offline authorization server may then generate license information based on the application information, one or more authorization codes corresponding to the application information, and the device fingerprint associated with each authorization code. If the information of the application to be run by the terminal device is matched with the application information in the license information, the authorization code acquired by the terminal device during registration is matched with one of the authorization codes in the license information and the device fingerprint of the terminal device is matched with one of the fingerprints in the license information, then the verification passes, or otherwise the verification fails.

For another example, the offline authorization server may generate license information according to all authorization codes that have been issued to the terminal devices, and the license information may include these authorization codes and the device fingerprint and application information associated with each authorization code. After receiving the license information, the terminal device compares its device fingerprint, authorization code and application information to be run with the license information. If the matched device fingerprint, authorization code and application information are found in the license information, the verification passes, or otherwise the verification fails.

According to the technical solution provided in the embodiments of the present disclosure, both the device fingerprint of the terminal device and the verification code acquired by the terminal device are used in the process of determining the verification result. The offline authorization server may acquire the list of authorization codes from the credit platform, so that the issuance of authorization code and the verification operation based on the license information may be performed in an offline scenario, thereby alleviating the problem of the application in the terminal device being copied or stolen, and protecting the rights and interests of application developers.

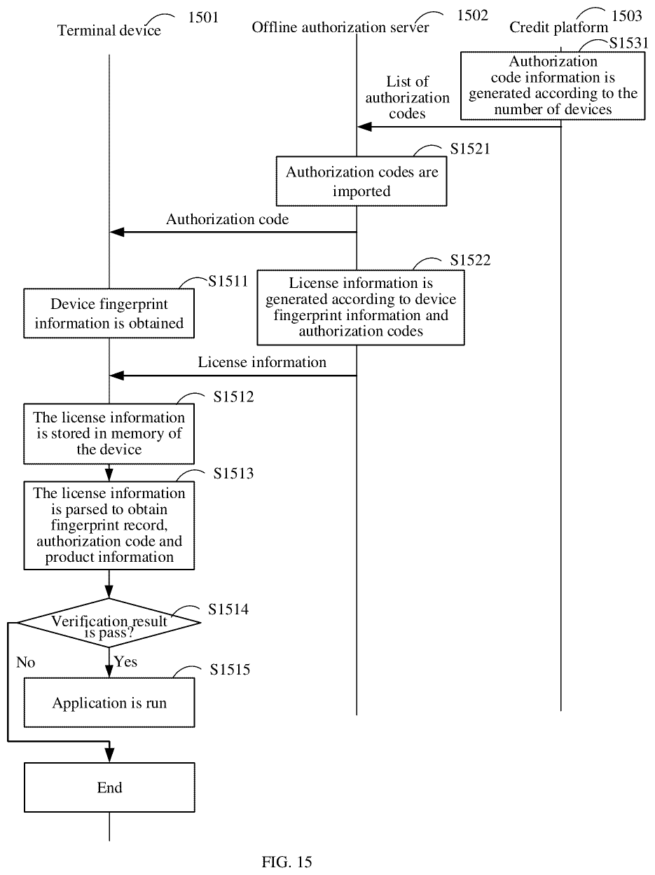

FIG. 15 is a schematic diagram of a principle of an offline mode according to an embodiment of the present disclosure.

As shown in FIG. 15, in operation S1531, a credit platform 1503 may generate a list of authorization codes according to the number of devices to be authorized, and send the list of authorization codes to an offline authorization server 1502. In operation S1521, the offline authorization server 1502 imports the authorization codes. In some embodiments, in addition to sending the list of authorization codes, the credit platform 1503 may further send a license file to the offline authorization server 1502. The license file indicates that the credit platform 1503 allows the offline authorization service to perform various operations such as issuing authorization codes on behalf of the credit platform 1503. After receiving the list of authorization codes, the offline authorization server 1502 and the terminal device 1501 may go offline relative to the credit platform 1503, that is, the terminal device 1501 and the offline authorization server 1502 may communicate on the same local area network. In this case, after the offline authorization server 1502 acquires the list of authorization codes, the terminal device 1501 and the offline authorization server 1502 may achieve authorization through the local area network, without communicating with the credit platform 1503 through the Internet.

The terminal device 1501 may acquire an authorization code from the offline authorization server 1502, and the authorization code is used to authorize the terminal device 1501 to run the application. In some embodiments, acquiring the authorization code includes: registering with the offline authorization server 1502; and receiving the authorization code from the offline authorization server 1502 in response to a successful registration, where the offline authorization server 1502 and the terminal device 1501 are in the same local area network. For example, the terminal device 1501 may send a registration request to the offline authorization server 1502. In response to the terminal device 1501 being registered with the offline authorization server 1502, the offline authorization server 1502 may send one of a plurality of authorization codes in the list of authorization codes to the terminal device 1501. For example, the offline authorization server 1502 may preset a quantity threshold according to a total number of authorization codes in the list of authorization codes, and query whether the number of currently registered terminal devices reaches the quantity threshold. If the number of currently registered terminal devices does not reach the quantity threshold, an authorization code that has not been associated with any device is sent to the terminal device 1501. It may be understood that if the number of currently registered terminal devices has reached the quantity threshold, it means that all authorization codes in the list of authorization codes have been associated with devices, then a notification of registration failure may be sent to the terminal device 1501. In some embodiments, the offline authorization server 1502 may also directly query whether an authorization code that has not been associated with any device exists in the list, and if so, send an authorization code to the terminal device 1501.

In operation S1511, the terminal device 1501 may acquire the device fingerprint in advance, and the device fingerprint is an identification information of the terminal device 1501. In some embodiments, the device fingerprint of the terminal device 1501 is determined according to the device identifier of the terminal device 1501. In some embodiments, determining the device fingerprint of the terminal device 1501 according to the device identifier of the terminal device 1501 includes: generating an initial string according to the device identifier of the terminal device 1501; and encrypting the initial string to obtain the device fingerprint. For example, for a terminal device having an Android system, it is possible to acquire SDK version and a device identifier android_id generated by the system, and then generate a device fingerprint through encryption. For example, in some embodiments, the device fingerprint may further include a model information and other hardware information of the terminal device 1501. In some embodiments, the terminal device 1501 may also customize a device fingerprint to support earlier versions and no permissions for acquisition.

The terminal device 1501 may acquire the license information from the offline authorization server 1502. In some embodiments, acquiring the license information includes: sending a verification request for the application to the offline authorization server 1502, and receiving the license information from the offline authorization server 1502. For example, the terminal device 1501 may send a verification request to the offline authorization server 1502. In operation S1522, the offline authorization server 1502 may generate, in response to the verification request, a license information according to the device fingerprints of the registered devices and the authorization code corresponding each device fingerprint. Continuing with reference to FIG. 15, in operating S1512, after acquiring the license information, the terminal device 1501 may save the license information to a local file system, such as a memory of the terminal device 1501.

As shown in FIG. 15, after acquiring the license information, the terminal device 1501 may extract from the license information the device fingerprint and the authorization code associated with the device fingerprint. In some embodiments, extracting from the license information the device fingerprint and the authorization code associated with the device fingerprint includes: decrypting the license information; and parsing the decrypted license information to obtain the device fingerprint and the authorization code associated with the device fingerprint. For example, the offline authorization server 1502 may encrypt the license information, and the terminal device 1501 may decrypt the encrypted license information. The encryption and decryption operations in this embodiment are similar to those for the license file described above, which will not be repeated here. After decryption, in operation S1513, the terminal device 1501 parses the license information to obtain the device fingerprint and the authorization code associated with the device fingerprint.

After parsing the license information, the terminal device 1501 generates a verification result by comparing the authorization code extracted from the license information with the acquired authorization code and comparing the device fingerprint extracted from the license information with the device fingerprint of the terminal device 1501 (operation S1514). The terminal device 1501 is allowed to run the application or prohibited from running the application according to the verification result (operation S1515). For example, if the authorization code extracted from the license information is consistent with the acquired authorization code and the device fingerprint extracted from the license information is consistent with the device fingerprint of the terminal device 1501, the verification result is a pass, otherwise the verification result is a fail.

In some embodiments, generating the verification result by comparing the authorization code extracted from the license information with the acquired authorization code and comparing the device fingerprint extracted from the license information with the device fingerprint of the terminal device includes: if the authorization code extracted from the license information is matched with the acquired authorization code and the device fingerprint extracted from the license information is matched with the device fingerprint of the terminal device, the verification result is a pass, otherwise the verification result is a fail. Allowing the terminal device to run the application or prohibiting the terminal device from running the application according to the verification result includes: allowing the terminal device to run the application if the verification result is a pass; and prohibiting the terminal device from running the application if the verification result is a fail.

In some embodiments, the license information may further include application information, such as a product identifier of the application. The method of running the application further includes: extracting application information from the license information, and comparing the application information extracted from the license information with information of the application to be run. Generating the verification result by comparing the authorization code extracted from the license information with the acquired authorization code and comparing the device fingerprint extracted from the license information with the device fingerprint of the terminal device includes: if the application information extracted from the license information is matched with the information of the application to be run, the authorization code extracted from the license information is matched with the acquired authorization code, and the device fingerprint extracted from the license information is matched with the device fingerprint of the terminal device, the verification result is a pass; otherwise, the verification result is a fail.

In some embodiments, the license information may further include an authorization validity period of the application. The terminal device 1501 may further perform the following operations: extracting from the license information the authorization validity period for the application; verifying whether the authorization validity period is valid; and prohibiting the terminal device 1501 from running the application in response to the authorization validity period being invalid.

Optionally, verifying whether the authorization validity period is valid includes: determining the authorization validity period to be valid in response to the authorization validity period extracted from the license information being consistent with an authorization validity period stored locally on the terminal device 1501; and determining the authorization validity period to be invalid in response to the authorization validity period extracted from the license information being inconsistent with the authorization validity period stored locally on the terminal device 1501.

Optionally, verifying whether the authorization validity period is valid includes: determining the authorization validity period to be valid in response to a current time being within the authorization validity period extracted from the license information; and determining the authorization validity period to be invalid in response to the current time being outside the authorization validity period extracted from the license information.

It may be understood that the authorization validity period for the terminal device in this embodiment is similar to that for the host described above, which will not be repeated here.

In addition, the offline authorization server 1502 and the credit platform 1503 in this embodiment may each contain one or more containers, which provide the offline authorization server 1502 and the credit platform 1503 with functions required to implement the above-mentioned solutions. The offline authorization server 1502 and the credit platform 1503 may adopt any scenario of a single machine and single container, a single machine and a plurality of containers, and a container cluster. These three scenarios support the method of running the application on the terminal device in this embodiment. It may be understood that it is also possible to verify whether container image information of the offline authorization server 1502 and of the credit platform 1503 is consistent with the image information in the corresponding configuration file. For detailed implementations, reference may be made to the above description related to the image sub-conditions of the host, which will not be repeated here.

According to the technical solution provided in the embodiments of the present disclosure, the offline authorization server may acquire the list of authorization codes from the credit platform, so that the issuance of authorization code and the verification operation based on the license information may be performed in an offline scenario. The information carried by the terminal device is first compared with the license information to determine the verification result, and the application is run in a case that the verification result is a pass. In a case that the verification result is a pass, the application is run. If there are problems such as the application is stolen or copied, the verification result may be a fail, and the application may not be run, thereby protecting the application, alleviating the problem of the application being copied or stolen, and protecting the rights and interests of application developers.

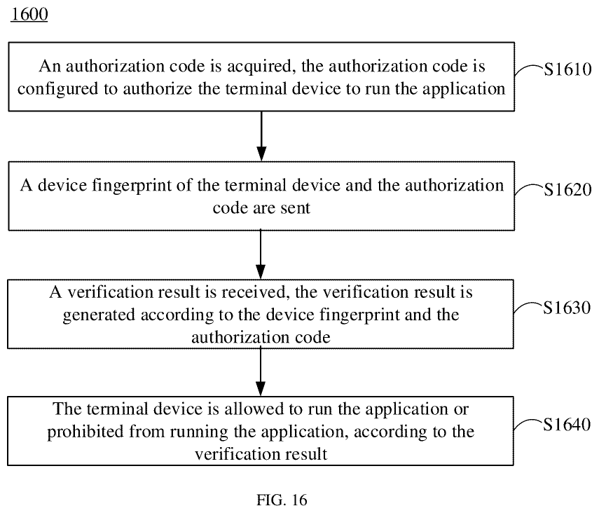

FIG. 16 is a schematic flowchart of a method of running an application according to an embodiment of the present disclosure.

As shown in FIG. 16, the present disclosure provides a method 1600 of running an application, and the method 1600 may be performed by a terminal device. The method 1600 may include operation S1610 to operation S1640.

In operation S1610, an authorization code is acquired, where the authorization code is used to authorize the terminal device to run the application.

For example, the terminal device may include various types of electronic devices, including but not limited to a mobile phone, a tablet computer, a mobile box, etc. The terminal device may have android, IOS, Linux or windows system. The terminal device may be installed with various applications, such as knowledge reading applications, web browser applications, search applications, instant messaging tools, email clients and/or social platform software, etc. (just for example). The terminal device may interact with a server to receive or send information.

In operation S1620, a device fingerprint of the terminal device and the authorization code are sent.

The device fingerprint is an identification information of the terminal device. As for the method of generating the device fingerprint, reference may be made to the generation method described in any of the above embodiments, which will not be repeated here.

In operation S1630, a verification result generated according to the device fingerprint and the authorization code is received.

In operation S1640, the terminal device is allowed to run the application or prohibited from running the application, according to the verification result.

It may be understood that the terminal device is allowed to run the application if the verification result is a pass, while the terminal device may be prohibited from running the application, for example, by prompting that the terminal device is not authorized and closing the application, if the verification result is a fail.

According to the technical solution provided in the embodiments of the present disclosure, both the device fingerprint of the terminal device and the authorization code acquired by the terminal device are used in the process of determining the verification result. In a case that the verification result is a pass, the application may be run. If there are problems such as the application is stolen or copied, the verification result may be a fail, and the application may not be run, thereby protecting the application, alleviating the problem of the application being copied or stolen, and protecting the rights and interests of application developers.

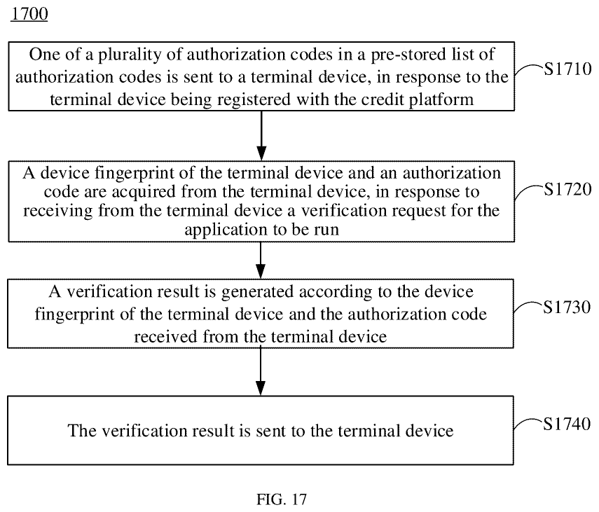

FIG. 17 is a schematic flowchart of a method of running an application according to an embodiment of the present disclosure.

As shown in FIG. 17, the present disclosure provides a method 1700 of running an application, and the method 1700 may be performed by a credit platform. The method 1700 may include operation S1710 to operation S1740.

In operation S1710, in response to a terminal device being registered with the credit platform, one of authorization codes in a pre-stored list is sent to the terminal device.

For example, each of the authorization codes in the list may be associated with only one terminal device. In response to the terminal device being registered with the credit platform, the credit platform may select, from the pre-stored list of authorization codes, an authorization code that has not been associated with any terminal device, and send the authorization code to the terminal device.

In operation S1720, in response to a verification request for the application to be run being received from the terminal device, a device fingerprint of the terminal device and an authorization code are acquired from the terminal device.

In operation S1730, a verification result is generated according to the device fingerprint of the terminal device and the authorization code.

For example, the credit platform may compare the device fingerprint and the authorization code acquired from the terminal device with a device fingerprint and an associated authorization code stored by the credit platform. If the device fingerprint acquired from the terminal device is consistent with the device fingerprint stored by the credit platform and the authorization code acquired from the terminal device is consistent with the authorization code associated with the device fingerprint stored by the credit platform, the verification result is a pass, otherwise the verification result is a fail.

In operation S1740, the verification result is sent to the terminal device.

According to the technical solution provided in the embodiments of the present disclosure, both the device fingerprint of the terminal device and the authorization code acquired by the terminal device are used in the process of determining the verification result. Through the list of authorization codes pre-stored on the credit platform, the issuance of authorization code and the verification operation may be performed in an online scenario, thereby alleviating the problem of the application being copied or stolen in the terminal device, and protecting the rights and interests of application developers.

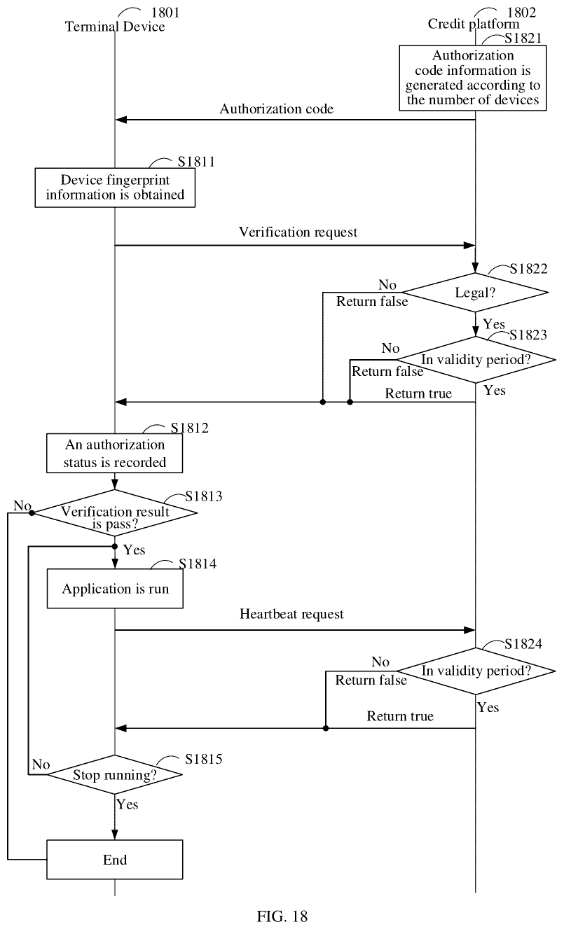

FIG. 18 is a schematic diagram of a principle of an online mode according to an embodiment of the present disclosure.

As shown in FIG. 18, in operation S1821, a credit platform 1802 may generate a list of authorization codes according to the number of devices to be authorized, and store the list of authorization codes. The terminal device 1801 may acquire an authorization code from the credit platform 1802, and the authorization code is used to authorize the terminal device 1801 to run the application. In some embodiments, acquiring the authorization code includes: registering with the credit platform 1802; and receiving the authorization code from the credit platform 1802 in response to a successful registration. For example, the terminal device 1801 may send a registration request to the credit platform 1802. In response to the terminal device 1801 being registered with the credit platform 1802, the credit platform 1802 may send one of the authorization codes in the list to the terminal device 1801. For example, the credit platform 1802 may preset a quantity threshold according to a total number of the authorization codes in the list, and query whether the number of currently registered terminal devices reaches the quantity threshold. If the number of currently registered terminal devices does not reach the quantity threshold, an authorization code that has not been associated with any device is sent to the terminal device 1801. It may be understood that if the number of currently registered terminal devices has reached the quantity threshold, it means that all authorization codes in the list of authorization codes have been associated with devices, then a notification of registration failure may be sent to the terminal device 1801. In some embodiments, the credit platform 1802 may also directly query whether an authorization code that has not been associated with any device exists in the list, and if so, send an authorization code to the terminal device 1801.

For example, in operation S1811, the terminal device 1801 may acquire the device fingerprint of the terminal device 1801, and sends a verification request to the credit platform 1802 for the application to be run. In some embodiments, the verification request may include the device fingerprint of the terminal device 1801 and the authorization code previously acquired by the terminal device 1801. In some embodiments, the verification request may not include the device fingerprint of the terminal device 1801 and the authorization code previously acquired by the terminal device 1801. In this case, the terminal device 1801 may send, in response to receiving a response information to the verification request from the credit platform 1802, the device fingerprint of the terminal device 1801 and the authorization code previously acquired by the terminal device 1801 to the credit platform 1802.

As shown in FIG. 18, after acquiring the device fingerprint of the terminal device 1801 and the authorization code, the credit platform 1802 may generate a verification result according to the device fingerprint of the terminal device 1801 and the authorization code. The credit platform 1802 may generate the verification result by comparing the device fingerprint acquired from the terminal device 1801 with the device fingerprint registered on the credit platform 1802 and comparing the authorization code acquired from the terminal device 1801 with the authorization code pre-stored by the credit platform 1802. In operation S1822, whether the terminal device 1801 is legal is determined according to the verification result. For example, if the device fingerprint acquired from the terminal device 1801 is consistent with the device fingerprint registered on the credit platform 1802, the authorization code acquired from the terminal device 1801 is consistent with the authorization code pre-stored by the credit platform 1802, and the device fingerprint is associated with the authorization code on the credit platform 1802, then the credit platform 1802 determines that the terminal device 1801 is legal and returns a first processing result as true to the terminal device 1801, or the next step may also be proceeded. In a case of not being consistent, the credit platform 1802 determines that the terminal device 1801 is illegal and returns the first processing result as false in a check status (status) to the terminal device 1801. Next, the credit platform 1802 may further perform the following operations: verifying whether the authorization validity period of the terminal device 1801 for the application is valid; and prohibiting the terminal device 1801 from running the application, in response to the authorization validity period being invalid. For example, in operation S1823, the credit platform 1802 queries a device service authorization validity period according to the device fingerprint information, compares the validity period with the current time of the credit platform 1802. If the validity period is before the current time of the credit platform 1802, it indicates that the validity period has expired. The credit platform 1802 may return a second processing result as false in the check status (status) to the terminal device 1801, otherwise the second processing result as true in the check status (status) is returned. It may be understood that the authorization validity period for the terminal device 1801 in this embodiment is similar to that for the host described above, which will not be repeated here.

After that, in operation S1812, the terminal device 1801 may record an authorization status. In operation S1813, the terminal device 1801 determines whether the verification result is a pass. If the verification result is a pass, the application is run (operation S1814). If the verification result is a fail, it ends. For example, the terminal device 1801 may determine whether to run the application according to a value returned by the verification interface of the credit platform 1802. For example, if the verification interface returns false, it indicates that the service has expired or the device is illegal, and the application may not be run at this time. For example, if the verification interface returns true, the application in the terminal device 1801 may be run.

In addition, after running the application, the credit platform 1802 may further verify a validity information of the terminal device 1801 online, so as to determine whether to stop running the application. For example, in the process of running a protected application, the terminal device 1801 may call an online verification interface of the credit platform 1802 and send a heartbeat request to the online verification interface every predetermined period of time. The predetermined period of time may be 1 hour, and the heartbeat request includes device fingerprint information and/or authorization code. In operation S1824, the credit platform 1802 may determine the validity information indicating whether the authorization validity period of the terminal device 1801 is in the valid state according to the device fingerprint information and/or authorization code. If the authorization validity period of the terminal device 1801 has expired, that is, the authorization validity period of the terminal device 1801 is in an invalid state, the credit platform 202 returns the validity information as false to the terminal device 1801, otherwise the validity information as true is returned. In operation S1815, the terminal device 1801 may determine whether to stop running the application according to the received validity information. For example, the terminal device 1801 may stop running the application in a case of receiving that the validity information is false, and the terminal device 1801 may continue running the application in a case of receiving that the validity information is true. In this embodiment, whether the authorization validity period of the terminal device 1801 has expired may be verified online in the process of running the application, and whether to close the application is determined based on the result of whether the authorization validity period of the terminal device 1801 has expired, thereby avoiding continuing running the application after the authorization validity period of the terminal device 1801 has expired.

In addition, the credit platform 1802 in this embodiment may contain one or more containers, which provide the credit platform 1802 with functions required to implement the solutions. The credit platform 1802 may adopt any scenario of a single machine and single container, a single machine and a plurality of containers, and a container cluster. These three scenarios support the method of running the application on the terminal device in this embodiment. It may be understood that it is also possible to verify whether container image information of the credit platform 1803 is consistent with the image information in the corresponding configuration file. For detailed implementations, reference may be made to the above description related to the image sub-conditions of the host, which will not be repeated here.

According to the technical solution provided in the embodiments of the present disclosure, both the device fingerprint of the terminal device and the authorization code acquired by the terminal device are used to generate the verification result. Through the list of authorization codes pre-stored on the credit platform, the issuance of authorization code and the verification operation may be performed in an online scenario. In a case that the verification result is a pass, the application may be run. If there are problems such as the application is stolen or copied, the verification result may be a fail, and the application may not be run, thereby protecting the application, alleviating the problem of the application being copied or stolen, and protecting the rights and interests of application developers.

The present disclosure further provides a system of running an application, including a credit platform, an offline authorization server and a terminal device. The credit platform is used to send a list of authorization codes to the offline authorization server. The offline authorization server is used to acquire the list of authorization codes from the credit platform, send one of the authorization codes in the list to the terminal device in response to the terminal device being registered with the offline authorization server, and send a license information to the terminal device in response to receiving a verification request from the terminal device. The terminal device is used to perform the above-mentioned method provided by the embodiments of the present disclosure.

The present disclosure further provides a system of running an application, including a credit platform and a terminal device. The credit platform is used to send one of a plurality of authorization codes in a pre-stored list of authorization codes to the terminal device in response to the terminal device being registered to the credit platform, acquire from the terminal device a device fingerprint of the terminal device and an authorization code, in response to receiving from the terminal device a verification request for the application to be run, generate a verification result according to the device fingerprint of the terminal device and the authorization code received from the terminal device, and send the verification result to the terminal device. The terminal device is used to perform the above-mentioned method provided by the embodiments of the present disclosure.

The present application further provides an electronic device, including: at least one processor; and a memory communicatively connected to the at least one processor. The memory stores instructions executable by the at least one processor, and the instructions are used to, when executed by the at least one processor, cause the at least one processor to implement the above-mentioned method provided by the embodiments of the present disclosure.

The present application further provides a non-transitory computer-readable storage medium having computer instructions therein, and the computer instructions are used to cause a computer to implement above-mentioned method provided by the embodiments of the present disclosure.

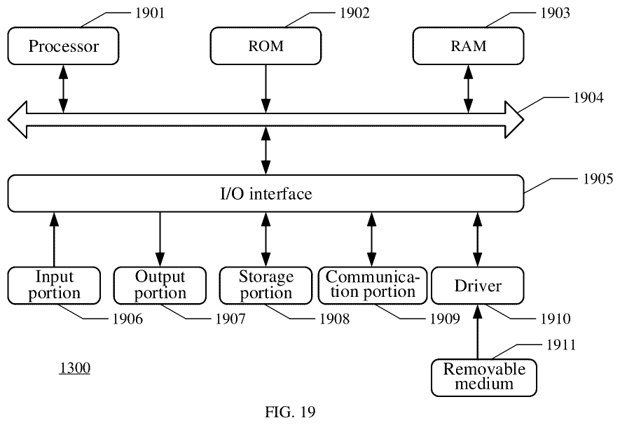

FIG. 19 is a block diagram of an electronic device applicable to implement a method of running an application according to an embodiment of the present disclosure.

As shown in FIG. 19, the electronic device 1900 according to the embodiment of the present disclosure includes a processor 1901, which may perform various appropriate actions and processes according to programs stored in a read-only memory (ROM) 1902 or programs loaded from a storage portion 1308 into a random access memory (RAM) 1903. The processor 1901 may include, for example, a general-purpose microprocessor (such as CPU), an instruction set processor and/or a related chipset and/or a specialized microprocessor (such as application specific integrated circuit (ASIC)), and so on. The processor 1901 may further include an onboard memory for caching purposes. The processer 1901 may further include a single processing unit or a plurality of processing units for performing different actions for the method flow according to the embodiment of the present disclosure.

In RAM 1903, various programs and data required for operations of the electronic device 1900 are stored. The processor 1901, ROM 1902 and RAM 1903 are connected to each other through a bus 1904. The processor 1901 performs various operations of the method flow according to the embodiment of the present disclosure by executing programs in ROM 1902 and/or RAM 1903. It should be noted that the program may also be stored in one or more memories other than ROM 1902 and RAM 1903. The processor 1901 may also perform various operations of the method flow according to the embodiment of the present disclosure by executing programs stored in the one or more memories.

According to the embodiment of the present disclosure, the electronic device 1900 may further include an input/output (I/O) interface 1905. The input/output (I/O) interface 1905 is also connected to the bus 1904. The electronic device 1900 may further include one or more of the following components connected to the I/O interface 1905: an input portion 1906 including a keyboard, a mouse, etc.; an output portion 1907 including a cathode ray tube (CRT), a liquid crystal display (LCD) and a speaker, etc.; a storage portion 1908 including a hard drive, etc.; and a communication portion 1909 including a network interface card such as an LAN card, a modem, etc. The communication portion 1909 performs communication processing through a network such as the Internet. A driver 1910 is also connected to I/O interface 1905 as desired. A removable medium 1911, such as a disk, an optical disk, a magneto-optical disk, a semiconductor memory, etc., are mounted on the driver 1910 as desired, so that the computer programs read out from the driver 1910 are installed into the storage portion 1908 as desired.

The present disclosure also provides a non-transitory computer readable storage medium. The computer-readable storage medium may be included in the device/apparatus/system described in the above embodiments. It may also exist separately without being assembled into the device/apparatus/system. The above-mentioned computer-readable storage medium stores one or more programs, and when the above one or more programs are executed, the method according to the embodiments of the present disclosure is implemented.

According to the embodiments of the present disclosure, the computer-readable storage medium may be a non-volatile computer readable storage medium. For example, it may include but not limited to a portable computer disk, a hard disk, a random access memory (RAM), a read-only memory (ROM), an erasable programmable read-only memory (EPROM or flash memory), a portable compact disk read-only memory (CD-ROM), an optical storage device, a magnetic storage device or any appropriate combination of the above. In the present disclosure, the computer-readable storage medium may be any tangible medium that contains or stores a program, which may be used by or in combination with an instruction execution system, an apparatus or a device. For example, according to the embodiments of the present disclosure, the computer-readable storage medium may include the ROM 1902 and/or RAM 1903 as described above and/or one or more memories other than the ROM 1902 and the RAM 1903.

The embodiments of the present disclosure further include a computer program product, which includes a computer program containing program code for executing the method shown in the flowchart. When the computer program product is running in the computer system, the program code is used to cause the computer system to implement the method of verifying process data of products provided in the embodiments of the present disclosure.

When the computer program is executed by the processor 1901, the above-mentioned functions defined in the system/apparatus of the embodiments of the present disclosure are executed. According to the embodiments of the present disclosure, the systems, apparatuses, modules, units, etc. described above may be implemented through computer program modules.

In an embodiment, the computer program may rely on tangible storage media such as optical storage device and a magnetic memory device. In another embodiment, the computer program may also be transmitted, distributed in the form of signals on the network medium, and downloaded and installed through the communication portion 1909, and/or installed from the removable medium 1911. The program code contained in this computer program may be transmitted using any suitable network medium, including but not limited to wireless, wired, etc., or any suitable combination of the above.

In such embodiments, the computer program may be downloaded and installed from the network through the communication portion 1909, and/or installed from the removable medium 1911. When the computer program is executed by processor 1901, the above-mentioned functions defined in the system of the embodiments of the present disclosure are executed. According to the embodiments of the present disclosure, the systems, devices, apparatuses, modules, units, etc. described above may be implemented through computer program modules.

According to the embodiments of the present disclosure, program codes for executing the computer program provided by the embodiments of the present disclosure may be written in any combination of one or more programming languages. Specifically, these computing programs may be implemented using advanced procedures and/or object-oriented programming languages, and/or assembly/machine languages. Programming languages include but are not limited to languages such as Java, C++, Python, “C” language or similar programming languages. Program codes may be completely executed on user computing devices, partially executed on user devices, partially executed on remote computing devices, or completely executed on remote computing devices or servers. In cases involving remote computing devices, remote computing devices may be connected to user computing devices through any type of networks, including local area network (LAN) or wide area network (WAN), or may be connected to external computing devices (such as using internet service providers to connect through the Internet).

The flowcharts and block diagrams in the accompanying drawings illustrate possible architectures, functions, and operations of the system, methods, and computer program products according to various embodiments of the present disclosure. In this regard, each box in a flowchart or block diagram may represent a module, program segment or part of code, and the above module, program segment or part of code contains one or more executable instructions for implementing the specified logical function. It should also be noted that in some alternative implementations, the functions indicated in the boxes may also occur in a different order than those indicated in the accompanying drawings. For example, two consecutive boxes may actually be executed substantially in parallel, and sometimes they may also be executed in reverse order, depending on the functionality involved. It should also be noted that each box in the block diagram or flowchart, and the combination of boxes in the block diagram or flowchart, may be implemented using dedicated hardware-based systems that perform specified functions or operations, or may be implemented using a combination of dedicated hardware and computer instructions.

Those of skill in the art may understand that the features recorded in the various embodiments and/or claims of the present disclosure may be associated or combined in various ways, even if such associations or combinations are not explicitly recorded in the present disclosure. Specifically, without departing from the spirit and teachings of the present disclosure, the features recorded in the various embodiments and/or claims of the present disclosure may be associated and/or combined in various ways. All these associations and/or combinations fall within the scope of the present disclosure.

Embodiments of the present disclosure have been described above. However, these embodiments are for illustrative purposes only and are not intended to limit the scope of the present disclosure. Although each embodiment is described separately above, this does not mean that the measures in the various embodiments may not be used in conjunction to advantage. The scope of the present disclosure is limited by the accompanying claims and their equivalents. Without departing from the scope of the present disclosure, those of skill in the art may make various substitutions and modifications, and all of which should fall within the scope of the present disclosure.

What is claimed is:

1. A method of running an application, performed by a terminal device, the method comprising:
acquiring an authorization code, wherein the authorization code is configured to authorize the terminal device to run the application;
acquiring a license information;
extracting a device fingerprint and an authorization code associated with the device fingerprint from the license information;
generating a verification result by comparing the authorization code extracted from the license information with the acquired authorization code and comparing the device fingerprint extracted from the license information with a device fingerprint of the terminal device; and
allowing the terminal device to run the application or prohibiting the terminal device from running the application, according to the verification result.

2. The method of claim 1, wherein the generating a verification result by comparing the authorization code extracted from the license information with the acquired authorization code and comparing the device fingerprint extracted from the license information with a device fingerprint of the terminal device comprises: if the authorization code extracted from the license information is matched with the acquired authorization code and the device fingerprint extracted from the license information is matched with the device fingerprint of the terminal device, determining the verification result as a pass; otherwise, determining the verification result as a fail; and
wherein the allowing the terminal device to run the application or prohibiting the terminal device from running the application according to the verification result comprises: allowing the terminal device to run the application if the verification result is a pass; and prohibiting the terminal device from running the application if the verification result is a fail.

3. The method of claim 2, further comprising: extracting application information from the license information, and comparing the application information extracted from the license information with an information of the application to be run; and
wherein the generating a verification result by comparing the authorization code extracted from the license information with the acquired authorization code and comparing the device fingerprint extracted from the license information with a device fingerprint of the terminal device comprises: if the application information extracted from the license information is matched with the information of the application to be run, the authorization code extracted from the license information is matched with the acquired authorization code and the device fingerprint extracted from the license information is matched with the device fingerprint of the terminal device, generating the verification result as a pass; otherwise, generating the verification result as a fail.

4. The method of claim 1, wherein the acquiring an authorization code comprises:
registering with an offline authorization server;
receiving the authorization code from the offline authorization server in response to a successful registration, wherein the offline authorization server is in the same local area network as the terminal device.

5. The method of claim 1, wherein the acquiring a license information comprises:
sending a verification request for the application to the offline authorization server; and
receiving the license information from the offline authorization server.

6. The method of claim 1, further comprising: after acquiring the license information,
storing the license information locally.

7. The method of claim 1, further comprising:
extracting an authorization validity period for the application from the license information;
verifying whether the authorization validity period is valid;
prohibiting the terminal device from running the application, in response to the authorization validity period being invalid.

8. The method of claim 7, wherein the verifying whether the authorization validity period is valid comprises:
determining the authorization validity period to be valid, in response to the authorization validity period extracted from the license information being consistent with an authorization validity period stored locally on the terminal device; or
determining the authorization validity period to be invalid, in response to the authorization validity period extracted from the license information being inconsistent with the authorization validity period stored locally on the terminal device.

9. The method of claim 7, wherein the verifying whether the authorization validity period is valid comprises:
determining the authorization validity period to be valid, in response to a current time being within the authorization validity period extracted from the license information; or
determining the authorization validity period to be invalid, in response to the current time being outside the authorization validity period extracted from the license information.

10. The method of claim 1, further comprising:
generating an initial string according to a device identifier of the terminal device; and
encrypting the initial string to obtain the device fingerprint.

11. The method of claim 1, wherein the extracting a device fingerprint and an authorization code associated with the device fingerprint from the license information comprises:
decrypting the license information;
parsing the decrypted license information to obtain the device fingerprint and the authorization code associated with the device fingerprint.

12. A method of running an application, performed by an offline authorization server, the method comprising:
acquiring a list of authorization codes from a credit platform;
sending one of the authorization codes in the list to a terminal device, in response to the terminal device being registered to the offline authorization server;
sending a license information to the terminal device in response to receiving a verification request from the terminal device, so that the terminal device performs the method of claim 1.

13. The method of claim 12, further comprising: before sending the authorization code to the terminal device, determining whether a number of authorized terminal devices exceeds a predetermined threshold;
wherein the operation of sending the authorization code to the terminal device is performed in response to the number of authorized terminal devices not exceeding the predetermined threshold.

14. A method of running an application, performed by a terminal device, the method comprising:
acquiring an authorization code, wherein the authorization code is configured to authorize the terminal device to run the application;
sending a device fingerprint of the terminal device and the authorization code;
receiving a verification result, wherein the verification result is generated according to the device fingerprint and the authorization code; and
allowing the terminal device to run the application or prohibiting the terminal device from running the application, according to the verification result.

15. The method of claim 14, wherein the acquiring an authorization code comprises:
registering with a credit platform; and
receiving the authorization code from the credit platform in response to a successful registration.

16. A method of running an application, performed by a credit platform, the method comprising:
sending one of a plurality of authorization codes in a pre-stored list of authorization codes to a terminal device, in response to the terminal device being registered with the credit platform;
acquiring from the terminal device a device fingerprint of the terminal device and an authorization code, in response to receiving from the terminal device a verification request for the application to be run;
generating a verification result according to the device fingerprint of the terminal device and the authorization code received from the terminal device; and
sending the verification result to the terminal device.

17. A system of running an application, comprising a credit platform, an offline authorization server, and a terminal device,
wherein the credit platform is configured to send a list of authorization codes to the offline authorization server;
wherein the offline authorization server is configured to acquire the list of authorization codes from the credit platform, send one of the authorization codes in the list to the terminal device in response to the terminal device being registered with the offline authorization server, and send a license information to the terminal device in response to receiving a verification request from the terminal device; and
wherein the terminal device is configured to perform the method of claim 1.

18. A system of running an application, comprising a credit platform and a terminal device,
wherein the credit platform is configured to send one of a plurality of authorization codes in a pre-stored list of authorization codes to the terminal device in response to the terminal device being registered to the credit platform, acquire from the terminal device a device fingerprint of the terminal device and an authorization code, in response to receiving from the terminal device a verification request for the application to be run, generate a verification result according to the device fingerprint of the terminal device and the authorization code received from the terminal device, and send the verification result to the terminal device; and
wherein the terminal device is configured to perform the method of claim 14.

19. An electronic device, comprising:
at least one processor; and
a memory communicatively connected to the at least one processor, wherein the memory stores instructions executable by the at least one processor, and the instructions are configured to, when executed by the at least one processor, cause the at least one processor to implement the method of claim 1.

20. A non-transitory computer-readable storage medium having computer instructions therein, wherein the computer instructions are configured to cause a computer to implement the method of claim 1.
